(19) United States
(12) Patent Application Publication
(10) Pub. No.: US 2005/0029234 A1
(43) Pub. Date: Feb. 10, 2005

(54) Resistance spot welding electrode

(76) Inventors: Feng Lu, Monroeville, PA (US); Pingsha Dong, Columbus, OH (US); Zhenning Cao, Dublin, OH (US)

Correspondence Address: BATTELLE MEMORIAL INSTITUTE, 505 KING AVENUE, COLUMBUS, OH, 43201-2693, US

(21) Appl. No.: 10/634,020

(22) Filed: Aug. 4, 2003

(51) Int. Cl. B23K 11/30

(52) U.S. Cl. 219/119

(57) ABSTRACT

A composite resistance spot welding electrode is disclosed which comprises a co-axial annular neck ring, a co-axial insert, a co-axial annular sleeve, or combinations there of. The electrode provides improved nugget formation and longer electrode life.

### FIELD OF THE INVENTION

This invention relates to electrodes for use in resistance spot welding, in particular to resistance spot welding of aluminum and aluminum alloys, and, in further particular, to composite electrodes having improved useful life and providing improved nugget formation when used to weld aluminum and alloys thereof.

### BACKGROUND OF THE INVENTION

Resistance spot welding (RSW) is characterized by placing two workpieces of base metal, for example, low-, medium-, and high-carbon steels, alloy steels, stainless steels, nickel and nickel-based alloys, copper and copper alloys, aluminum, magnesium, titanium, and other alloys, including dissimilar metals or similar metals with the same of different sheet thicknesses. adjacent to one another, forcing the tip of at least one electrode against at least one of the workpieces, and passing a finite number of current cycles via the at least one electrode through the two workpieces. Metals with higher electrical resistivity and lower thermal conductivity are considered to be more amenable to RSW since it is possible to use a more-desirable lower welding current. When the base metals exhibit high thermal expansion, warping and buckling of the welded assembly can be a problem. In addition, hardness is a factor. Soft metals will be marked easily by the electrodes unless low electrode forces are used. Conversely, hard, strong metals require greater force to ensure adequate contact between the electrode and the workpiece. Finally, other factors such as oxide formation and plastic range can have significant affects on RSW.

In operation, resistance to the current melts the base metal at the interface between the two workpieces (the faying surface), thereby creating a lenticular-shaped zone of initially molten base metal which, when fused, forms a nugget which secures the two workpieces together. The current is typically short-time-pulsed, low-voltage, and high-amperage.

The electrodes used in RSW must exhibit the ability to conduct electricity to the workpiece efficiently, effectively transmit the necessary pressure to the workpiece, and rapidly transfer heat away from the interface between the electrode and the workpiece. Therefore, the most desirable electrodes will have high electrical and thermal conductivities, high hardness at elevated temperatures, and sufficient structural strength and stiffness to withstand the rigors of the weld process.

RSW is the most widely used joining method for thin sheet metals, particularly in the automotive industry. There is, particularly in the automotive industry, growing interest in the use of aluminum and aluminum alloys in automobile structures. (It is to be understood herein that any reference to aluminum, unless otherwise indicated, refers also to aluminum alloys.) It is recognized, further, that RSW is a key technology in the volume production of aluminum sheet structures. While conventional RSW is quite satisfactory for joining, for example, steels, other metals, particularly aluminum, present unique problems. First, aluminum has a high chemical affinity for oxygen and, therefore, forms a film of oxide when exposed to air. This oxide film not only presents a barrier of high electrical resistance which must be overcome to supply current to the workpiece, it also exhibits high heat transfer which conducts heat away from the workpiece so quickly that a nugget may not form properly. In addition, the oxide layer has a high melting point—an important consideration also at the interface between the two sheets. These attributes result in the need for higher current densities and associated higher electrode temperatures to produce a satisfactory weld. Second, aluminum itself has high thermal and electrical conductivities as well as a high heat of fusion. To overcome these properties and generate enough heat at the weldsite to create a satisfactory nugget, a higher welding current is required in a relatively shorter period of time. Finally, aluminum has a narrower plastic temperature range and a larger thermal expansion coefficient. These properties necessitate a high electrode force in order to avoid inner stress-induced cracking during the nugget formation process. In addition, the required electrode force for aluminum, relative to surface hardness, is much higher than, for example, steel. However, since contact resistance is inversely proportional to electrode force, a higher current density is required to create the necessary heat to form a satisfactory nugget when a higher electrode force is used. The force is generally of such a magnitude that, along with the increased temperature of the electrode due to high current densities, a mushrooming affect is observed around the periphery of the electrode tip. The combination of these properties imposes a severe working environment of high mechanical and thermal stresses upon the electrodes. The electrodes are run hotter and, at the same time, subjected to higher forces. This, in turn, results in shorter electrode life, reduced productivity, and higher cost operations.

As an example of the difficulty of using RSW on a metal like aluminum, consider the following comparison shown in Table 1 below.

TABLE 1

| Parameter | Galvanized Steel [1] | Aluminum [2] |
|---|---|---|
| Base Metal Thickness (mm) | 2.0 | 2.0 |
| Current (KA) | 16.7 | 25 |
| Force (pounds-force) | 1400 | 1573 |
| Weld Time (cycles) | 19 | 8 |
| Life (welds) [1] | 5,000 | 500 |

### SOURCES

[1] Updated Technology, Resistance Welding Course—2000,4-22 (2000). Basis: Flat-tip Cu-Zr electrode and low-carbon galvanized steel.
[2] M. Hao, et al., Developments in Characterization of Resistance Spot Welding of Aluminum, Welding J., vol. 75, no. 1, 1s-8s (1996). Basis: Dome- or spherical-shaped tip Cu—Zr electrode and 5XXX aluminum.
   The reason the indicated electrodes function at all with aluminum is the fact that a dome-shaped tip is used so that more concentrated contact is achieved and mushrooming is minimized. As the electrodes are used, however, the mushrooming affect, noted above, causes a degradation in the quality of the nugget. As shown, after a limited number of welds, the electrodes must be replaced.

These and other problems have been approached in several ways. It is known, for example, to include a thick annular sleeve of high strength and high electrical resistivity material around the tip of a copper electrode as well a co-axial insert at the center of the tip surface. For example, U.S. Pat. No. 4,514,612 to Nied teaches such a configuration to control and improve both thermal and mechanical conditions. The Nied configuration is said to minimize the mushrooming that can occur around the periphery of the electrode tip as the result of high temperature and high forces and help channel current flow into the central region of the electrode. When applied to aluminum, however, the Nied electrode exhibits unacceptably high current densities and resultant higher temperatures in the vicinity of the sleeve and unacceptably low temperatures at the faying surface. Similarly, U.S. Pat. No. 3,689,731 to Miller teaches the use of a high electrical resistivity washer offset from the tip face. When used in aluminum applications, the configuration of the Miller electrode directs the majority of the current flow around a slot formed to receive the washer and only a very small portion of the current flows to the center of the electrode. In addition, the current tends to “bleed back” around the slot resulting in insufficient current at the interface between the electrode and the workpiece. The result is poor or no weld formation. In addition, stress concentration in the Miller electrode at the interface between the relatively soft electrode and the workpiece directly below the relatively hard washer can damage the electrode and shorten its life.

Thus, there is a need for an improved electrode, particularly for welding aluminum and similar metals, which forms satisfactory nuggets with lower energy requirements and which electrode exhibits a longer useful life.

### BRIEF DESCRIPTION OF THE INVENTION

It is, therefore, an object of the present invention to provide an improved electrode for RSW, and particularly for RSW of aluminum.

It is a further object of the present invention to provide an RSW electrode which effects improved welds, offers increased electrode life, and has lower electrical energy requirements.

It is yet a further object of the present invention to provide an RSW electrode comprising a composite tip, which electrode comprises, individually or in combination, a high-strength, low thermal- and electrical-conductivity insert co-axial with the tip, a high-strength, low thermal- and electrical-conductivity annular sleeve co-axial with the tip, and a high-strength, low thermal- and electrical-conductivity ring co-axial with the tip in a spaced-apart relation to a face of the tip.

It is yet a further object of the present invention to provide an RSW electrode comprising an insert and a sleeve of proportions relative to the electrode whereby the current flow path is confined and whereby a comparably-sized nugget is formed with fewer welding cycles, reduced peak welding current values, or both, relative to welding utilizing traditional electrodes.

It is yet a further object of the present invention to provide RSW electrodes which offer improved electrode pressure distribution and reduced electrode tip heating and plastic deformation of the electrode.

Examples of empirical results, together with results from incrementally-coupled finite element analysis (FEA) models, are used to illustrate the new design.

The above and other objects, features, and advantages of the present invention will be made more apparent from the following specification taken in conjunction with the accompanying drawings which illustrate preferred embodiments of the present invention by way of example.

### BRIEF DESCRIPTION OF THE DRAWINGS

FIG. 1a is a cross-section of a pair of prior art electrodes and also showing a workpiece as well as a nugget.

FIG. 1b is an FEA graphic of the type of prior art electrodes and workpiece shown in FIG. 1a showing the current density profile during operation.

FIG. 1c is an FEA graphic of the type of prior art electrodes and workpiece shown in FIG. 1a showing the temperature profile during operation.

FIG. 1d is a plot of the temperature during operation at the interface between the type of prior art electrodes and the workpiece shown in FIG. 1a.

FIG. 1e is a plot of the current density during operation at the interface between the type of prior art electrodes and the workpiece shown in FIG. 1a.

FIG. 1f is a plot of the contact pressure at the interface between the type of prior art electrodes and the workpiece shown in FIG. 1a.

FIG. 2a is a cross-section of a pair of prior art composite copper electrodes comprising a heavy-duty annular sleeve and a center insert and also showing a workpiece.

FIG. 2b is an FEA graphic of the type of prior art electrodes and workpiece shown in FIG. 2a showing the current density profile during operation.

FIG. 2c is an FEA graphic of the type of prior art electrodes and workpiece shown in FIG. 2a showing the temperature profile during operation.

FIG. 3a is a cross-section of a pair of prior art composite copper electrodes comprising an offset support washer and also showing a workpiece.

FIG. 3b is an FEA graphic of the type of prior art electrodes and workpiece shown in FIG. 3a showing the current density profile during operation.

FIG. 3c is an FEA graphic of the type of prior art electrodes and workpiece shown in FIG. 3a showing the temperature profile during operation.

FIG. 3d is a plot of the contact pressure at the interface during operation between the type of prior art electrodes and the workpiece shown in FIG. 3a.

FIG. 4a is a cross-section of a pair of electrodes comprising an insert, a sleeve, and a ring according to the present invention and also showing a workpiece as well as a nugget.

FIG. 4b is an FEA graphic of the type of electrodes and workpiece shown in FIG. 4a showing the current density profile during operation.

FIG. 4c is an FEA graphic of the type of electrodes and workpiece shown in FIG. 4a showing the temperature profile during operation.

FIG. 4d is a plot of the temperature during operation at the interface between type of the electrodes and the workpiece shown in FIG. 4a.

FIG. 4e is a plot of the current density during operation at the interface between the type of electrodes and the workpiece shown in FIG. 4a.

FIG. 4f is a plot of the contact pressure during operation at the interface between the type of electrodes and the workpiece shown in FIG. 4a.

FIG. 5a is a cross-section of a pair of electrodes comprising an insert, a sleeve, and a ring according to another aspect of the present invention and also showing a workpiece as well as a nugget.

FIG. 5b is an FEA graphic of the type of electrodes and workpiece shown in FIG. 5a showing the current density profile during operation.

FIG. 5c is an FEA graphic of the type of electrodes and workpiece shown in FIG. 5a showing the temperature profile during operation.

FIG. 5d is a plot of the temperature during operation at the interface between the type of electrodes and the workpiece shown in FIG. 5a.

FIG. 5e is a plot of the current density during operation at the interface between the type of electrodes and the workpiece shown in FIG. 5a.

FIG. 5f is a plot of the contact pressure during operation at the interface between the type of electrodes and the workpiece shown in FIG. 5a.

FIG. 6a is a cross-section of a pair of electrodes comprising a sleeve according to another aspect of the present invention and also showing a workpiece as well as a nugget.

FIG. 6b is an FEA graphic of the type of electrodes and workpiece shown in FIG. 6a showing the current density profile during operation.

FIG. 6c is an FEA graphic of the type of electrodes and workpiece shown in FIG. 6a showing the temperature profile during operation.

FIG. 6d is a plot of the temperature at the interface during operation between the type of electrodes and the workpiece shown in FIG. 6a.

FIG. 6e is a plot of the current density during operation at the interface between the type of electrodes and the workpiece shown in FIG. 6a.

FIG. 6f is a plot of the contact pressure during operation at the interface between the type of electrodes and the workpiece shown in FIG. 6a.

FIG. 7a is a cross-section of a pair electrodes comprising a sleeve according to another aspect of the present invention and also showing a workpiece as well as a nugget.

FIGS. 7b-7e are FEA graphics of nugget formation with varying sleeve dimensions according to the aspect of the present invention shown in FIG. 7a.

FIG. 8a is a cross-section of a pair of electrodes comprising an insert according to another aspect of the present invention and also showing a workpiece as well as a nugget.

FIG. 8b is an FEA graphic of the type of electrodes and workpiece shown in FIG. 8a showing the current density profile during operation.

FIG. 8c is an FEA graphic of the type of electrodes and workpiece shown in FIG. 8a showing the temperature profile during operation.

FIG. 8d is a plot of the temperature at the interface during operation between the type of electrodes and the workpiece shown in FIG. 8a.

FIG. 8e is a plot of the current density during operation at the interface between the type of electrodes and the workpiece shown in FIG. 8a.

FIG. 8f is a plot of the contact pressure during operation at the interface between the type of electrodes and the workpiece shown in FIG. 8a.

FIG. 9a is a cross-section of a pair of electrodes comprising an insert according to another aspect of the present invention and also showing a workpiece as well as a nugget.

FIGS. 9b-9e are FEA graphics of nugget formation with varying insert dimensions according to the aspect of the present invention shown in FIG. 9a.

FIG. 10a is a cross-section of a pair of electrodes comprising a ring according to another aspect of the present invention and also showing a workpiece as well as a nugget.

FIG. 10b is an FEA graphic of the type of electrodes and workpiece shown in FIG. 10a showing the current density profile during operation.

FIG. 10c is an FEA graphic of the type of electrodes and workpiece shown in FIG. 10a showing the temperature profile during operation.

FIG. 10d is a plot of the temperature during operation at the interface between the type of electrodes and the workpiece shown in FIG. 10a.

FIG. 10e is a plot of the current density during operation at the interface between the type of electrodes and the workpiece shown in FIG. 10a.

FIG. 10f is a plot of the contact pressure during operation at the interface between the type of electrodes and the workpiece shown in FIG. 10a.

FIG. 11a is a cross-section of a pair of electrodes comprising a ring according to another aspect of the present invention and also showing a workpiece as well as a nugget.

FIGS. 11b-11d are FEA graphics of nugget formation with varying ring dimensions according to the aspect of the present invention shown in FIG. 11a.

FIG. 12a is a cross-section of a pair of electrodes comprising an insert, a sleeve, and a ring according to another aspect of the present invention and also showing a workpiece as well as a nugget.

FIG. 12b is an FEA graphic of the type of electrodes and workpiece shown in FIG. 12a showing the current density profile during operation.

FIG. 12c is an FEA graphic of the type of electrodes and workpiece shown in FIG. 12a showing the temperature profile during operation.

FIG. 12d is a plot of the temperature during operation at the interface between the type of electrodes and the workpiece shown in FIG. 12a.

FIG. 12e is a plot of the current density during operation at the interface between the type of electrodes and the workpiece shown in FIG. 12a.

FIG. 12f is a plot of the contact pressure during operation at the interface between the type of electrodes and the workpiece shown in FIG. 12a.

FIG. 13a is a cross-section of a pair of electrodes comprising an insert and a sleeve according to another aspect of the present invention and also showing a workpiece as well as a nugget.

FIG. 13b is an FEA graphic of the type of electrodes and workpiece shown in FIG. 13a showing the current density profile during operation.

FIG. 13c is an FEA graphic of the type of electrodes and workpiece shown in FIG. 13a showing the temperature profile during operation.

FIG. 13d is a plot of the temperature during operation at the interface between the type of electrodes and the workpiece shown in FIG. 13a.

FIG. 13e is a plot of the current density during operation at the interface between the type of electrodes and the workpiece shown in FIG. 13a.

FIG. 13f is a plot of the contact pressure during operation at the interface between the type of electrodes and the workpiece shown in FIG. 13a.

FIG. 14a is a cross-section of a pair of electrodes comprising an insert and a sleeve according to another aspect of the present invention and also showing a workpiece as well as a nugget.

FIG. 14b is an FEA graphic of the type of electrodes and workpiece shown in FIG. 14a showing the current density profile during operation.

FIG. 14c is an FEA graphic of the type of electrodes and workpiece shown in FIG. 14a showing the temperature profile during operation.

FIG. 14d is a plot of the temperature during operation at the interface between the type of electrodes and the workpiece shown in FIG. 14a.

FIG. 14e is a plot of the current density during operation at the interface between the type of electrodes and the workpiece shown in FIG. 14a.

FIG. 14f is a plot of the contact pressure during operation at the interface between the type of electrodes and the workpiece shown in FIG. 14a.

FIG. 15a is a cross-section of a pair of electrodes comprising an insert and a sleeve according to another aspect of the present invention and also showing a workpiece as well as a nugget.

FIG. 15b is an FEA graphic of the type of electrodes and workpiece shown in FIG. 15a showing the current density profile during operation.

FIG. 15c is an FEA graphic of the type of electrodes and workpiece shown in FIG. 15a showing the temperature profile during operation.

FIG. 15d is a plot of the temperature during operation at the interface between the type of electrodes and the workpiece shown in FIG. 15a.

FIG. 15e is a plot of the current density during operation at the interface between the type of electrodes and the workpiece shown in FIG. 15a.

FIG. 15f is a plot of the contact pressure during operation at the interface between the type of electrodes and the workpiece shown in FIG. 15a.

FIG. 16a is a cross-section of a pair of electrodes comprising an insert and a sleeve according to another aspect of the present invention and also showing a workpiece as well as a nugget.

FIG. 16b is an FEA graphic the type of electrodes and workpiece shown in FIG. 16a showing the current density profile during operation.

FIG. 16c is an FEA graphic of the type of electrodes and workpiece shown in FIG. 16a showing the temperature profile during operation.

FIG. 16d is a plot of the temperature during operation at the interface between the type of electrodes and the workpiece shown in FIG. 16a.

FIG. 16e is a plot of the current density during operation at the interface between the type of electrodes and the workpiece shown in FIG. 16a.

FIG. 16f is a plot of the contact pressure during operation at the interface between the type of electrodes and the workpiece shown in FIG. 16a.

FIG. 17a is a cross-section of a pair of electrodes comprising an insert, a sleeve, and a ring according to another aspect of the present invention and also showing a workpiece as well as a nugget.

FIG. 17b is an FEA graphic of the type of electrodes and workpiece shown in FIG. 17a showing the current density profile during operation.

FIG. 17c is an FEA graphic of the type of electrodes and workpiece shown in FIG. 17a showing the temperature profile during operation.

FIG. 17d is a plot of the temperature during operation at the interface between the type of electrodes and the workpiece shown in FIG. 17a.

FIG. 17e is a plot of the current density during operation at the interface between the type of electrodes and the workpiece shown in FIG. 17a.

FIG. 17f is a plot of the contact pressure during operation at the interface between the type of electrodes and the workpiece shown in FIG. 17a.

FIG. 18a is a cross-section of a pair of electrodes comprising an insert according to another aspect of the present invention and also showing a workpiece as well as a nugget.

FIGS. 18b-18d are FEA graphics of nugget formation with varying insert dimensions in combination with a sleeve according to the aspect of the present invention shown in FIG. 18a.

FIG. 19a is a cross-section of a pair of electrodes comprising an insert, a sleeve, and a ring according to another aspect of the present invention and also showing a workpiece as well as a nugget.

FIGS. 19b-19d are FEA graphics of nugget formation with varying insert dimensions in combination with both a sleeve and a ring according to the aspect of the present invention shown in FIG. 19a.

FIGS. 20a, 21a, 22a, and 23a are duplicate cross-sections of a pair of electrodes comprising an insert and a sleeve according to another aspect of the present invention and also showing a workpiece, and, in the case of FIGS. 22a and 23a, a nugget.

FIGS. 20b-20f, 21b-21f, 22b-22f, and 23b-23f are FEA graphics and plots showing current densities, contact pressures, and temperatures at varying current cycles according to the aspect of the present invention shown in FIGS. 20a, 21a, 22a, and 23a, respectively.

FIGS. 24a and 24b are FEA graphics of current densities and temperatures, respectively, showing nugget formation according to an aspect of the present invention comprising an insert and a sleeve.

FIGS. 25a and 25b are FEA graphics of current densities and temperatures, respectively, showing nugget formation according to an aspect of the present invention comprising an insert and a ring.

FIGS. 26a and 26b are FEA graphics of current densities and temperatures, respectively, showing nugget formation according to an aspect of the present invention comprising an insert, a sleeve, and a ring.

FIGS. 27a and 27b are plots of nugget sizes versus weld time (cycles) for FEA computer program-predicted values compared with experimental values.

### DETAILED DESCRIPTION OF THE INVENTION AND BEST MODE

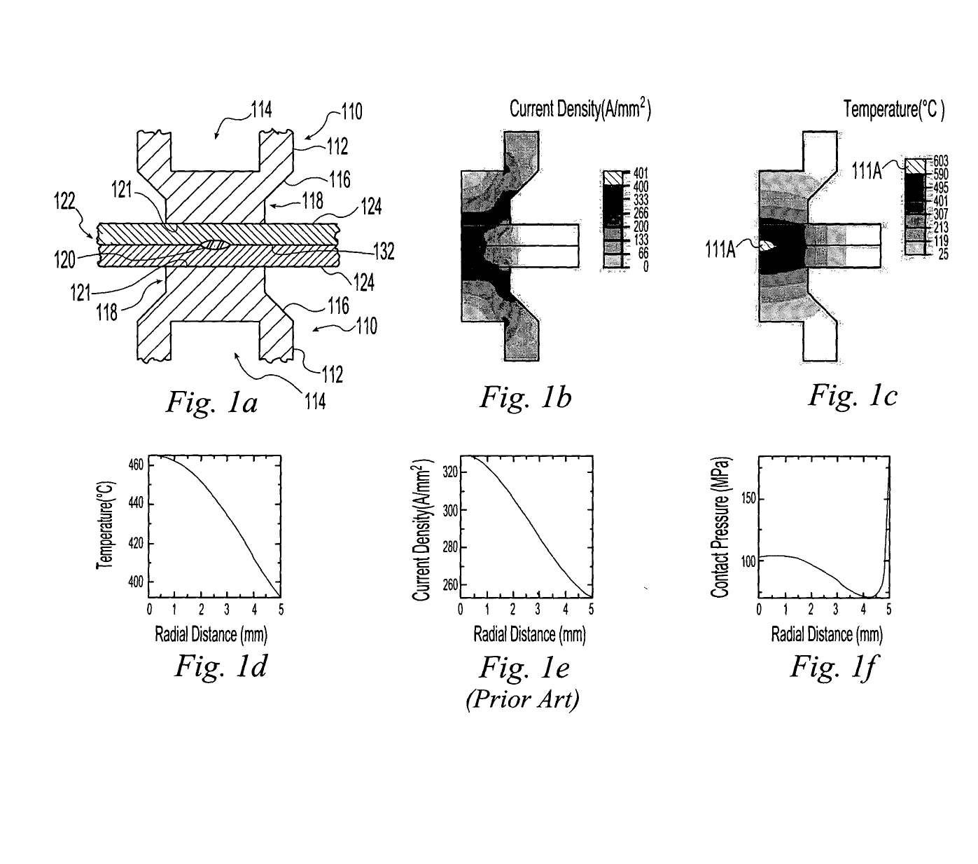

Turning first to FIG. 1a, a pair of conventional prior art copper electrodes 110 of the indicated design is shown. Each electrode 110 comprises first a shank portion 112 which, for purposes of comparison, has a diameter of 16 mm which is formed to include a coolant channel 114 having a diameter of 9 mm in which cold water or other suitable coolant circulates to help cool the electrode 110 during use. (In the FEA analyses presented herein, the coolant is water at ambient temperature (20 deg. C.).) Second is a tapered section 116, adjacent to, and integral with, the shank portion 112. For purposes of comparison, the tapered portion 116 has a height in the axial direction of 3 mm and an angle relative to the radius of 45 degrees. Third is a tip portion 118, adjacent to, and integral with, the tapered portion 116. Again, for purposes of comparison, the tip portion 118 has a height in the axial direction of 2.4 mm and a diameter of 10 mm. The tip portion 118 is formed to include a flat face 121. The flat face 121 was chosen for consistency and to provide a proper comparison with the electrodes of the present invention. While a particular electrode shape is shown using pure copper, those skilled in the art will recognize that there are many different shapes used in RSW applications and that various copper alloys may be used for the electrode 110. Furthermore, those skilled in the art will also recognize that each of the pair of electrodes 110 need not be identical.

During operation, the pair of electrodes 110 are arranged in a facing, spaced-apart relationship, a workpiece 122, comprising two pieces of sheet metal 124 is interposed between the electrodes 110, the workpiece 122 is then squeezed between the electrodes 110 with a specified force, and a current of specified amperage is applied for a specified number of electrical cycles. The current flow causes the temperature of the faying surface 132 between the two pieces of sheet metal 124 to rise causing the metal to melt and, when fused, to form a solid nugget 120.

Turning next to FIGS. 1b-1f, the conditions during operation for the configuration of FIG. 1a are illustrated. In all FEA examples shown herein, the conditions shown in Table 2 below were used unless otherwise specified.

TABLE 2

| Parameter | Value |
|---|---|
| Base Metal Type | 5XXX Al |
| Base Metal Thickness (mm) | 2 |
| Total Workpiece Thickness (mm) | 4 |
| Electrode Material | Cu |
| Current (KA) | 22 |
| Force (pounds-force) | 1550 |
| Weld Time (cycles) | 10 |
| Squeeze Time (cycles) | 60 |

FIG. 1b shows the current density profile throughout the electrodes 110 and the workpiece 122. The current density profile shows that the current is distributed over the entire interface between the electrode face 121 and the workpiece 122. In addition, the current is concentrated near the faying surface 132. Similarly, FIG. 1c shows the temperature profile. The highest temperature range 111A is between 590-603 deg. C. and indicates the formation of a nugget 120. In this example, however, the nugget 120 is too small to be effective. For a nugget 120 to be effective, it must have a vertical coverage, the percent of the thickness of the nugget 120 to the total thickness of the workpiece 122 of between 20 and 80 percent and preferably about 40 percent and have a diameter as large as possible. For example, if the nugget 120 is to thin, the weld will have insufficient strength, if the nugget 120 is too thick, however, the high temperature can cause the electrode 110 to become overheated. The nugget 120 in the example shown in FIGS. 1a and 1c, however, is only 0.96 mm thick, or 24 percent of the total 4 mm thickness of the workpiece 122. This dimension is acceptable, but at the lower end of the desired range and well below the preferred value of 40 percent. The diameter of the nugget 120 is 3.1 mm.

FIG. 1d shows the temperature profile (deg. C.) along the interface between the electrode face 121 and the workpiece 122. As shown, the peak temperature of 470 deg. C is at the center of the electrode face 121 and steadily decreases to 390 deg. C. at the periphery of the face 121. This temperature range is well below the melting point of copper (1080 deg. C.) to avoid deformation of the electrode.

FIG. 1e shows the current density profile (A/mm²) along the same interface described in FIG. 1d. As with the temperature, the current density is higher at the center of the interface between the electrode face 121 and the workpiece 122 and steadily decreases toward the periphery of the face 121. This last phenomenon is undesirable since, in order to form a large-diameter nugget, the current should be distributed radially as far as possible.

FIG. 1f shows the contact pressure profile (MPa) along the same interface described in FIG. 1d. Both the center of the interface (0 mm Radial Distance) and the periphery (5 mm Radial Distance) experience the highest contact pressures. The periphery, in fact, experiences a significantly higher contact pressure which can cause degradation and mushrooming of the electrode face 121 at the periphery.

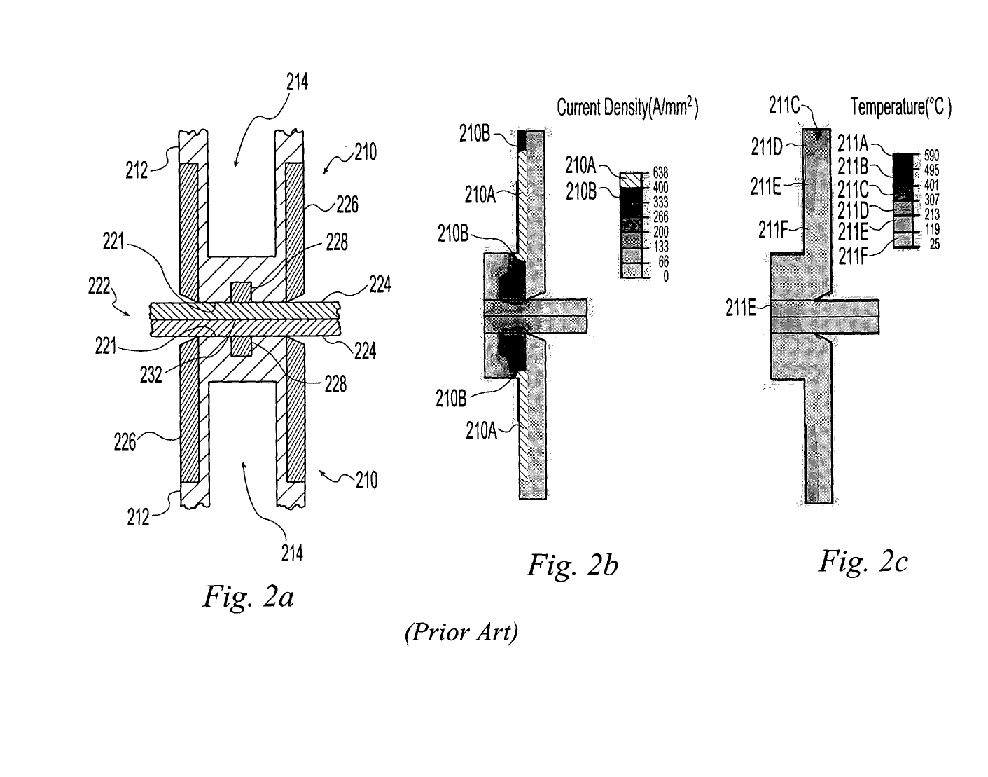

Turning now to FIGS. 2a-2c, a pair of prior art electrodes 210 according to Nied, above, is shown. Each electrode 210 comprises a shank portion 212 having a diameter of 16 mm, which is formed to include a coolant channel 214 having a diameter of 9 mm, an annular sleeve 226 having a thickness in the radial direction of 2.3 mm, and a co-axial insert 228 having a diameter of 2 mm. Also shown is a workpiece 222 comprised of two aluminum sheets 224. As shown in FIG. 2b, using an insert 229 and a sleeve 226 of 304 stainless steel (SS), the current load necessary to weld aluminum creates high current densities and higher-than-desirable electrode temperatures in some locations and lower-than-desirable electrode temperatures in other locations (FIG. 2c). For example, the current densities 210A, 210B in the undesirable location between the sleeve 226 and the coolant channel 214, produces higher-than-desirable electrode temperatures 211D, 211E back in the shank portion 212 and lower-than-desirable temperatures 211F at the interface between the face 221 and the workpiece 222. More importantly, however, the temperature 211E at the faying surface 232 is insufficient to create a nugget.

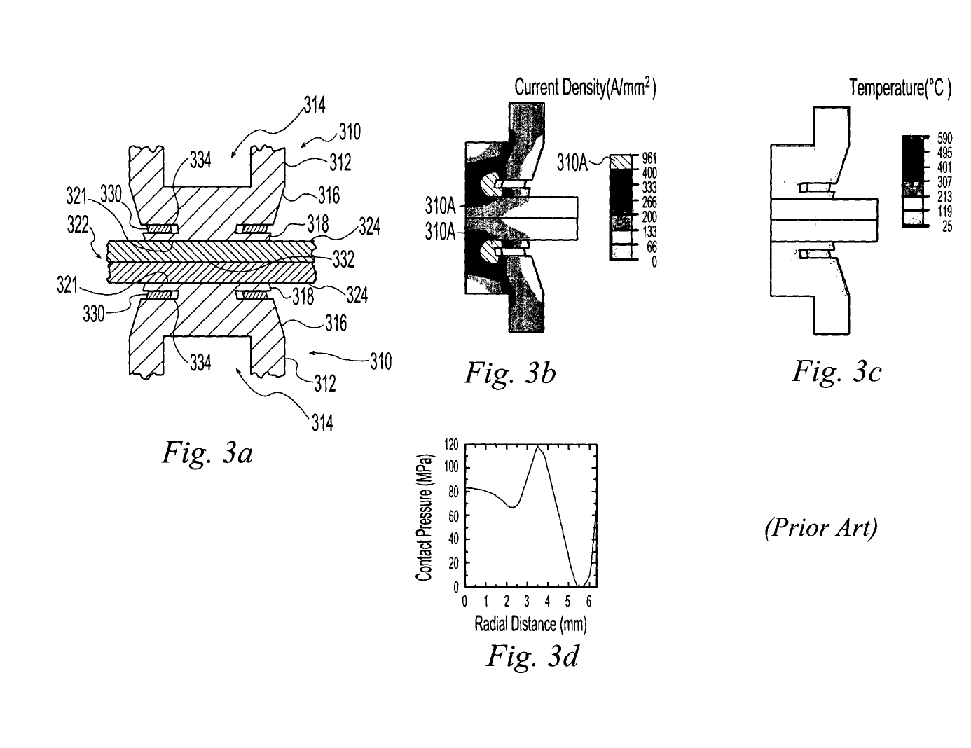

Turning next to FIGS. 3a-3d, a pair of prior art electrodes 310 comprises first a shank portion 312, a tapered portion 316, and a tip portion 318. In addition, an annular washer 330 is inserted into an annular slot 334. Drawing from information disclosed in Miller, the diameter of the tip portion 318 is one-half inch (12.7 mm), the annular washer 330 is one thirty-second inch thick (0.8 mm) in the axial direction and offset from the tip face one thirty-second inch (0.8 mm). The horizontal depth of the slot 334 in the radial direction is one-eighth inch (0.3 mm). As shown in FIG. 3b, during operation, the nature of the 304 SS annular washer 330 so positioned causes a region of high current density 310A and a “bleed back” of current attempting to ground to the workpiece 322 along the path of least resistance. In addition, the indicated conditions fail to produce a nugget because the temperature at the faying surface 332 is too low. Finally, as shown in FIG. 3d, the interaction of the high-strength (Miller at 2:7) 304 SS annular washer 330 with the relatively soft copper and the force required to clamp the workpiece 322 causes an undesirable spike in the contact pressure which will, over time, deteriorate the electrode 310. Table 3 below summarizes the properties of interest.

TABLE 3

| | Yield Strength | Brinell | Melting Point |
|---|---|---|---|
| Property | (MPa) | Hardness | (deg. C.) |
| Copper (Cu) | 110 | 75 | 1080 |
| 304 SS | 240 | 150 | 1430 |

### SOURCE

Marks' Standard Handbook for Mechanical Engineering 6.66 Eugene A. Avallone and Theodore Baumeister III eds., 9th ed. (1987).

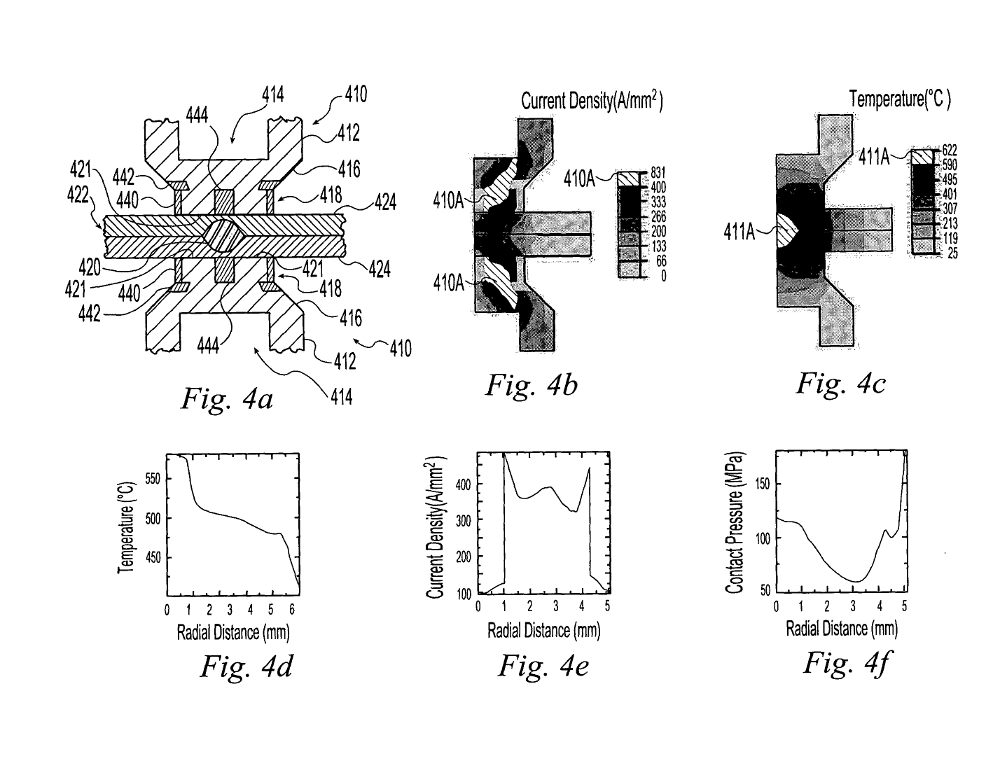

Turning now to an embodiment of the present invention, FIG. 4a shows a pair of electrodes 410 comprising first a shank portion 412, which, for purposes of comparison, has a diameter of 16 mm, but which can vary from 8-24 mm depending upon the application, which is formed to include a coolant channel 414 having a diameter of 9 mm. The coolant channel 414 diameter may vary depending upon the diameter of the shank 412. In addition, the coolant channel 414 shape may vary depending upon the application. Second is a tapered section 416, adjacent to, and integral with, the shank portion 412. Again, for purposes of comparison, the tapered portion 416 has a height in the axial direction of 3 mm and an angle relative to the radius of 45 degrees, but which can vary from 0 mm (no tapered section 416) to about 8 mm and have an angle of 30-90 degrees relative to the radius depending upon the application. Third is a tip portion 418, adjacent to, and integral with, the tapered portion 416. Again, for purposes of comparison, the tip portion 418 has a height in the axial direction of 2.4 mm and a diameter of 10 mm. For consistency and comparison purposes, the tip portion 418 is formed to include a flat face 421. Each electrode 410 also comprises first an annular sleeve 440 having a thickness in the radial direction between 0.5-2.5 mm, preferably between 0.5-1 mm, and more preferably 0.75 mm, or, more generally, between 10-50 percent of the radius of the tip 418, preferably between 10-20 percent of the radius of the tip 418, and more preferably 15 percent of the radius of the tip 418 and a height in the axial direction between 1-5 mm, preferably between 2-3 mm, and more preferably 2.4 mm, or, more generally, between 20-80 percent of the distance from the face 421 to the bottom of the coolant channel 414, preferably between 40-50 percent of the distance from the face 421 to the bottom of the coolant channel 414, and more preferably 45 percent of the distance from the face 421 to the bottom of the coolant channel 414. Second, a co-axial insert 444 having a diameter of 2 mm, preferably between 1-6 mm, more preferably between 3-5 mm, and more preferably 4 mm, or, more generally, between 10-60 percent of the diameter of the tip 418, preferably between 30-50 percent of the diameter of the tip 418, and more preferably 40 percent of the diameter of the tip 418 and a height in the axial direction between 1-5 mm, preferably between 2-3 mm, and more preferably 2.4 mm, or, more generally between 20-80 percent of the distance from the face 421 to the bottom of the coolant channel 414, preferably between 40-50 percent of the distance from the face 421 to the bottom of the coolant channel 414, and more preferably 45 percent of the distance from the face 421 to the bottom of the coolant channel 414. Third, an annular ring 442 having a thickness in the radial direction of between 0.5-3 mm, preferably between 1-3 mm, and more preferably 1.5 mm, or, more generally, between 10-60 percent of the radius of the tip 418, preferably between 20-40 percent of the radius of the tip 418, and more preferably 30 percent of the radius of the tip 418 and a height in the axial direction of between 0.5-2 mm, preferably between 0.75-1.5 mm, and more preferably 1 mm, or more generally, between 10-40 percent of the distance from the tip face 421 to the bottom of the coolant channel 414, preferably between 15-30 percent of the distance from the tip face 421 to the bottom of the coolant channel 414, and more preferably 20 percent of the distance from the tip face 421 to the bottom of the coolant channel 414.

In the example shown in FIGS. 4b-4f, the electrode 410 is copper and the sleeve 440 (0.75 mm thick in the radial direction and 2.4 mm high in the axial direction), the insert 444 (2 mm diameter and 2.4 mm high in the axial direction), and the ring 442 (1.5 mm thick in the radial direction and 1 mm high in the axial direction) are 304 SS. Other stainless steels and even other metals with high strength and low thermal and electrical conductivities will also work satisfactorily. And, for the insert, tungsten will also be satisfactory.

FIG. 4b shows the current density profile throughout the electrodes 410 and the workpiece 422. The affects of the sleeve 440, the insert 444, and the ring 442 on the current density are shown as greatly improved flow of current through the electrodes 410 to the workpiece 422. More importantly, an improved, larger nugget 420 is formed as shown by the 590 deg. C.-plus temperature zone 411A. (FIG. 4c.) In the example shown, the nugget 440 is 3.34 mm thick, or 84 percent of the total 4 mm thickness of the workpiece 422. The diameter of the nugget 420 is 4.5 mm.

FIG. 4d shows the temperature distribution along the interface of the electrode tip face 421 and the workpiece 422. The temperature at the center is relatively high due to the presence of the low thermal conductivity SS insert 444. The copper portion of the electrode face 421 experiences a temperature (500 deg. C.), only slightly higher than that of a plain copper electrode (FIG. 1d).

FIG. 4e shows the current density distribution along the interface of the electrode tip face 421 and the workpiece 422. As shown, the current density along both the insert 444 and the sleeve 440 is very low, but it is high and nearly uniform throughout the copper portion of the electrode tip face 421 which indicates that the current flows more efficiently in that area. (Compare FIG. 1e.)

FIG. 4f shows the contact pressure distribution along the interface of the electrode tip face 421 and the workpiece 422. Both the center and the periphery have relatively higher contact pressures which enables the insert 444 and the sleeve 440 to minimize any excess pressure on the copper portion of the tip face 421. (Compare FIG. 1f.)

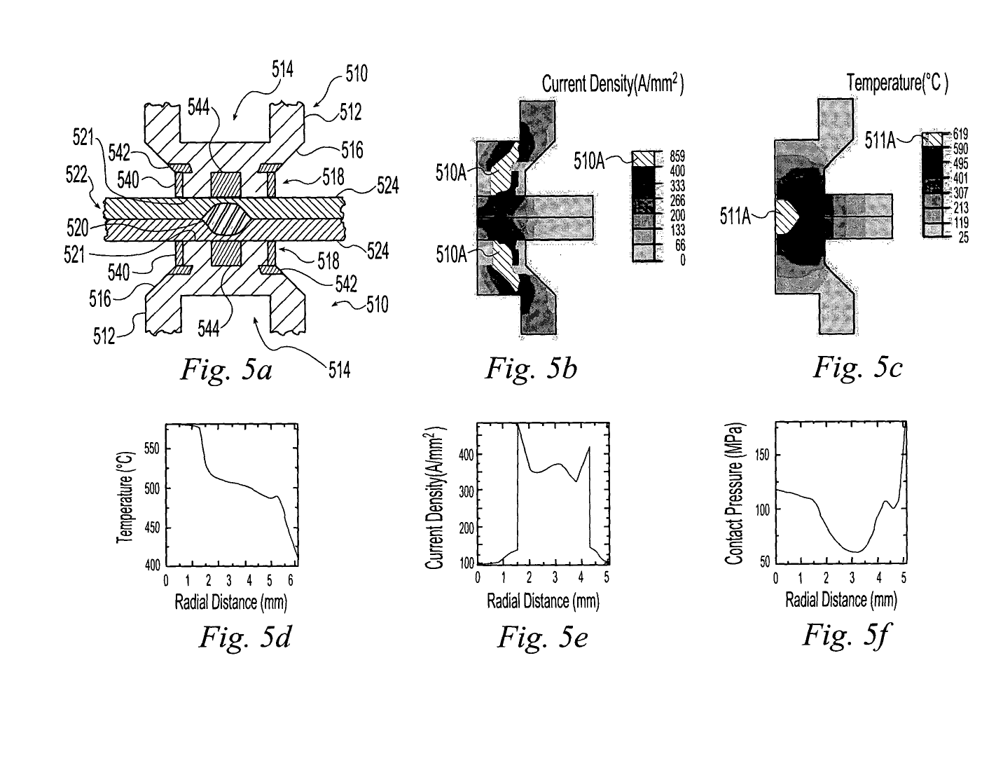

A modification of the embodiment shown in FIGS. 4a-4f is shown in FIGS. 5a-5f. Reference numerals are analogous to those used in FIGS. 4a-4c. Dimensions of the electrodes 510 are the same with the exception of the insert 544 which is 3 mm (versus 2 mm in FIGS. 4b-4f) in diameter. The composition of all components is the same as that shown in FIGS. 4a-4f.

FIG. 5b shows a somewhat enlarged current density profile compared with that shown in FIG. 4b. The nugget 520 (shown in FIG. 5c as temperature zone 511A) is 3.34 mm thick, or 84 percent of the total 4 mm thickness of the workpiece 522. The diameter of the nugget 520 is 5 mm. Thus, compared with the nugget 420 shown in FIG. 4c, the nugget 520 shown in FIG. 5c is the same thickness but slightly wider.

As in FIGS. 4d-4f, the plots shown in FIGS. 5d-5f are somewhat different from those of FIGS. 1d-1f, respectively. Note that the peak current density in FIG. 5e is higher than the comparable value in FIG. 4e because of the narrower current flow path caused by the wider diameter insert 544. In turn, the higher current density leads to a larger weld nugget 520.

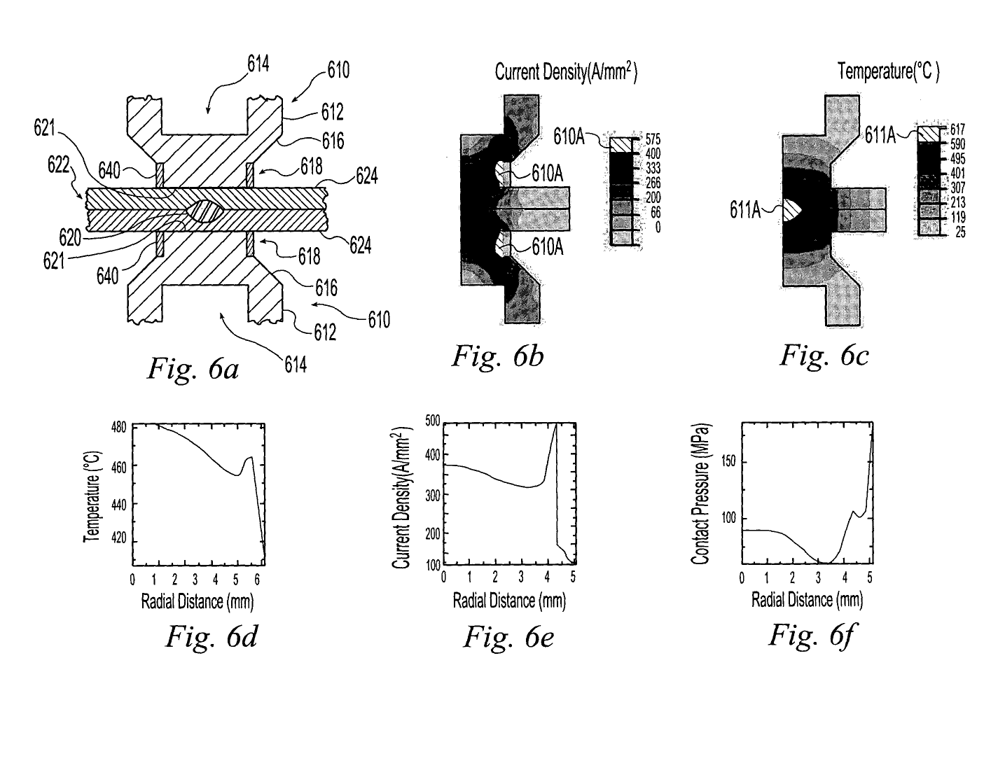

Another embodiment of the instant invention is shown in FIG. 6a. Reference numerals are analogous to those used in FIGS. 4a-4c. Dimensions of analogous structures of the electrodes 610 are the same as those in the electrodes 410 shown in FIG. 4a. The electrode 610 shown in FIG. 6a, however, comprises only an added sleeve 640.

In the example shown in FIGS. 6b-6f, the sleeve 640 has a thickness in the radial direction of 0.75 mm and a height in the axial direction of 2.4 mm. The nugget 620 (shown in FIG. 6c as temperature zone 611A) is 2.12 mm thick, or 53 percent of the total 4 mm thickness of the workpiece 622. The diameter of the nugget 640 is 3.6 mm.

Referring now to FIGS. 6d-6f, temperature, current density, and contact pressure are nearly uniform along the interface between the tip face 621 and the workpiece 622. The sleeve 640 takes the high pressure at the periphery of the electrode tip 610. Overall, this electrode 610 produces a smaller weld nugget 620 than the electrodes 410, 510 shown in FIGS. 4a and 5a respectively but provides a larger nugget 620 than the plain copper electrode 110 and more desirable mechanical conditions (i.e., reduced mushrooming).

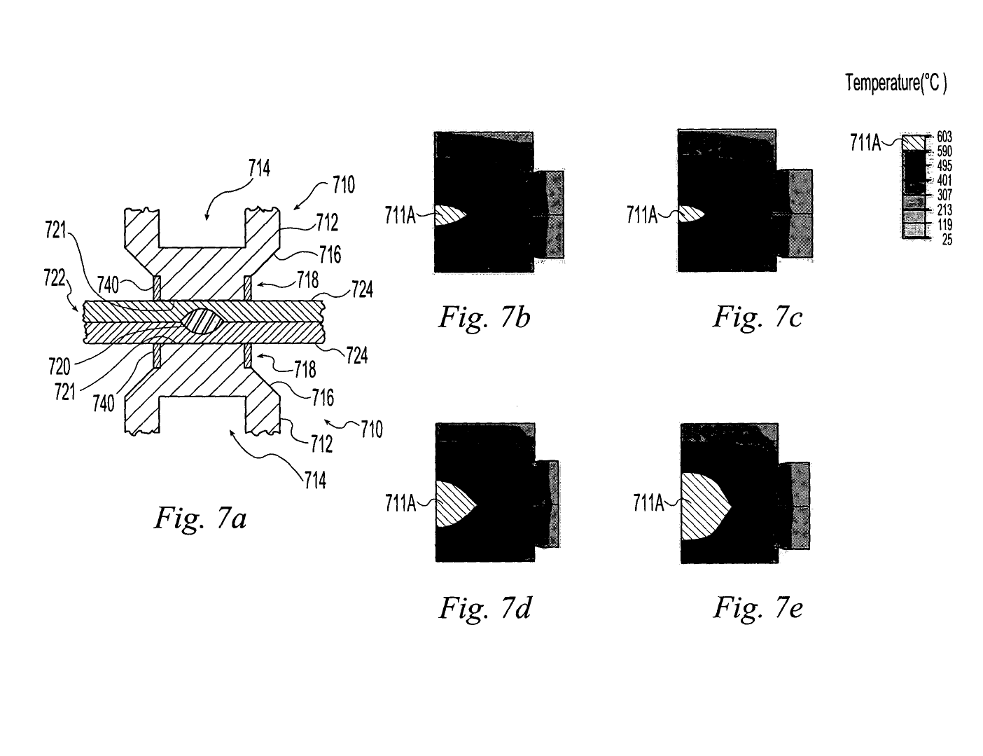

FIGS. 7a-7e (FIG. 7a is referenced as above.) illustrate the affects of changing SS sleeve 740 thickness on the size and proportions of the nugget 720. All basic dimensions are the same as the earlier versions. Table 4 below compares the proportions of the nugget 720.

TABLE 4

| | | | | |
|---|---|---|---|---|
| Annular Ring Thickness (mm) | 0.0 | 0.5 | 0.75 | 1.0 |
| Nugget Thickness (mm) | 0.96 | 0.66 | 2.12 | 3.2 |
| Nugget Diameter (mm) | 3.1 | 2.76 | 3.60 | 5.16 |
| Nugget Vertical Coverage (%) | 24 | 17 | 53 | 80 |

Thus, with the annular ring 740 alone, a larger thickness effects a larger nugget 720 in both thickness as well as the diameter. The apparent anomaly for the 0.5 mm thickness appears to be caused by the sleeve 740 being thinner and farther away from the axis and tracking much of the current near its inner surface. (Compare FIG. 7c for a thickness of 0.5 mm with FIG. 7e for a thickness of 1.5 mm.)

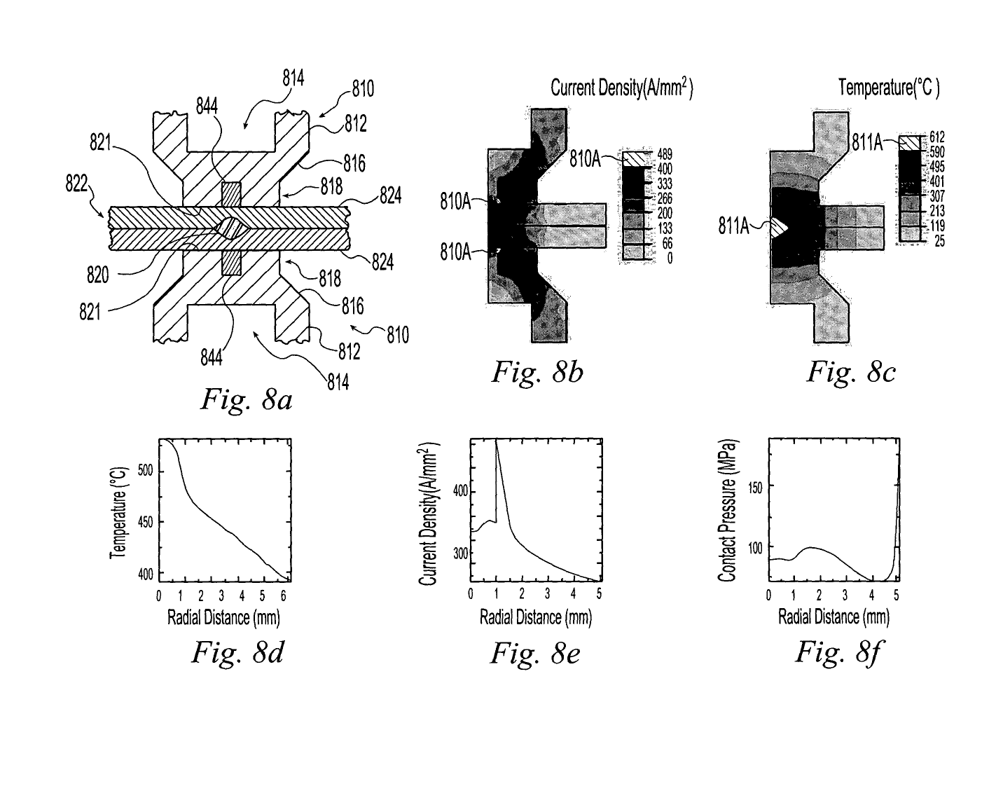

Another embodiment of the instant invention is shown in FIG. 8a. Reference numerals are analogous to those used in FIGS. 4a-4c. Dimensions of analogous structures of the electrodes 810 are the same as those in the electrodes 410 shown in FIG. 4a. The electrode 810 shown in FIG. 8a, however, comprises only an added insert 844.

In the example shown in FIGS. 8b-8f, the insert 840 has a diameter of 2 mm and a height in the axial direction of 2.4 mm. In this example, the insert 840 is tungsten, not 304 SS. The nugget 820 (shown in FIG. 8c as temperature zone 811A) is 2 mm thick, or 50 percent of the total 4 mm thickness of the workpiece 822. The diameter of the nugget 840 is 3.6 mm.

FIGS. 8d and 8e show how the insert 844, which is stronger and has a higher melting temperature than copper, withstands higher temperatures and stresses. However, as shown in FIG. 8f, the periphery of the electrode tip face 821 experiences high contact pressure which can cause mushrooming.

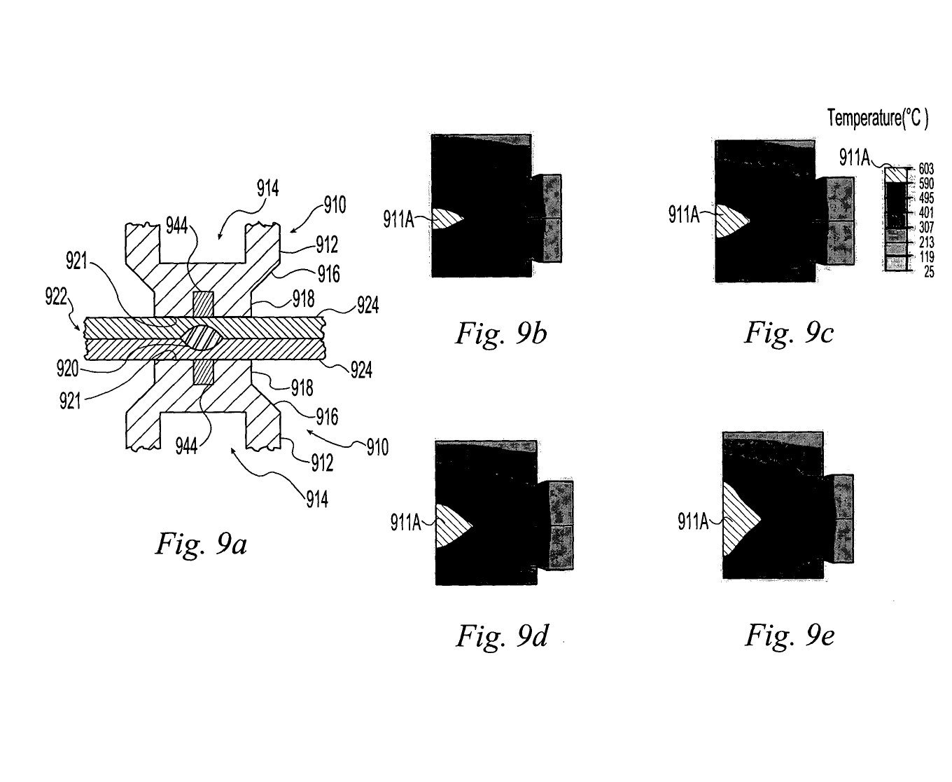

FIGS. 9a-9e (FIG. 9a is referenced as above.) illustrate the affects of changing tungsten insert 944 diameter on the size and proportions of the nugget 920. All basic dimensions are the same as earlier versions. Table 5 below compares the proportions of the nugget 920.

TABLE 5

| | | | | |
|---|---|---|---|---|
| Co-axial Insert Thickness (mm) | 0 | 1.5 | 2 | 3 |
| Nugget Thickness (mm) | 0.96 | 1.54 | 2 | 3.34 |
| Nugget Diameter (mm) | 3.10 | 3.5 | 3.6 | 3.76 |
| Nugget Vertical Coverage (%) | 24 | 39 | 50 | 84 |

Thus, with the insert 944 alone, a larger diameter effects a much thicker nugget 920 with a proportionally smaller increase in diameter. As the diameter of the insert 944 increases, the nugget 920 is increased primarily in the thickness dimension, which, as noted above, can cause the electrode 910 to experience higher temperatures which can cause the electrode 910 to soften and mushroom at the periphery. Thus, the diameter of the insert 944 can be too large, and an optimum may exist for a particular application.

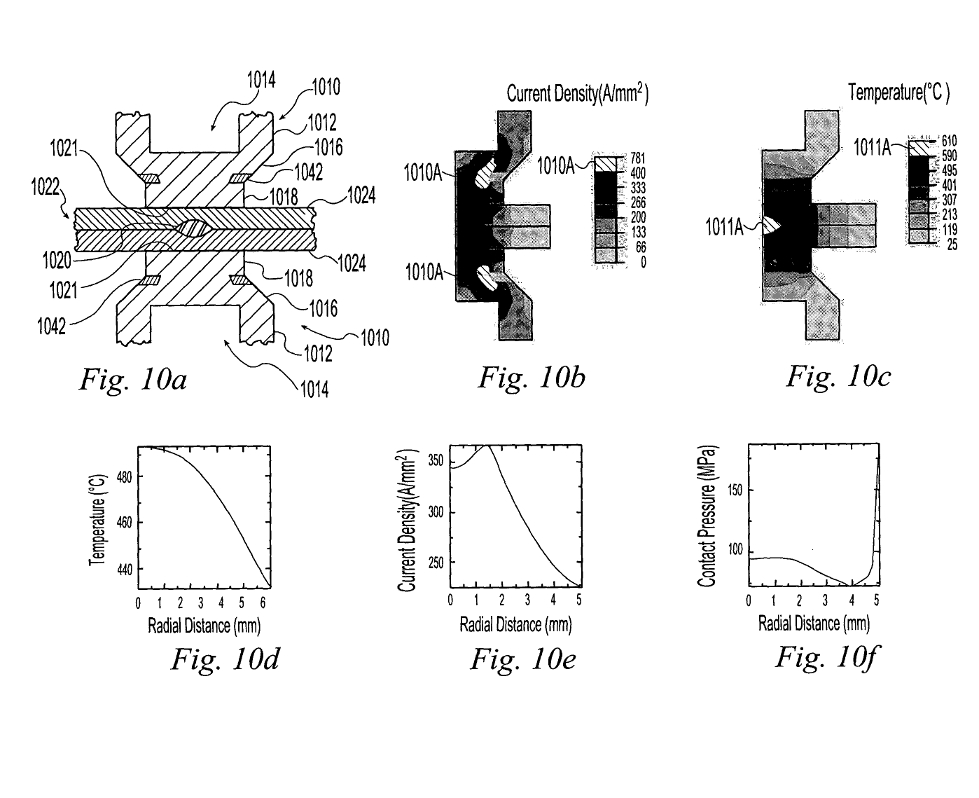

Another embodiment of the present invention is shown in FIG. 10a. Reference numerals are analogous to those used in FIGS. 4a-4c. Dimensions of analogous structures of the electrodes 1010 are the same as those in the electrodes 410 shown in FIG. 4a. The electrode in 1010 shown in FIG. 10a, however, comprises only an added ring 1042.

In the example shown in FIGS. 10b-10f, the ring 1042 has a thickness in the radial direction of 1.5 mm and a height in the axial direction of 1 mm. In this example, the ring 1042 is SS. The nugget 1020 (shown in FIG. 10c as temperature zone 1011A) is 1.66 mm thick, or 42 percent of the total 4 mm thickness of the workpiece 1022. The diameter of the nugget 1040 is 4 mm.

FIGS. 10d-10f show plots of temperature, current density, and contact pressure similar to those in FIGS. 1d-1f. Again, the periphery of the electrode 1010 experiences high pressure, which may cause mushrooming.

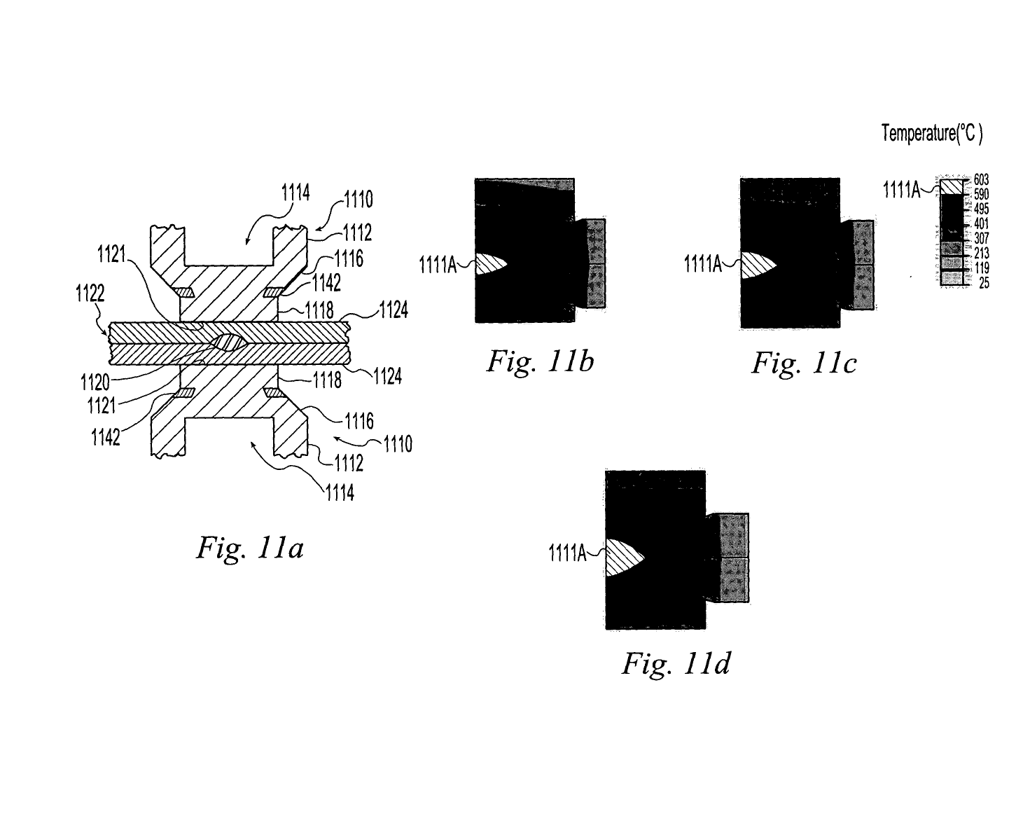

FIGS. 11a-11d (FIG. 11a is referenced as above.) illustrate the affects of changing the thickness of the ring 1142 on the size and proportions of the nugget 1120. All basic dimensions are the same as earlier dimensions. Table 6 below compares the proportions of the nugget 1120.

TABLE 6

| | | | |
|---|---|---|---|
| Neck Ring Thickness (mm) | 0 | 1 | 1.5 |
| Nugget Thickness (mm) | 0.96 | 1.20 | 1.66 |
| Nugget Diameter (mm) | 3.1 | 3.5 | 4 |
| Nugget Vertical Coverage (%) | 24 | 30 | 42 |

Thus, with the ring 1142 alone, an increase in the thickness of the ring 1142 in the radial direction tends to enlarge the nugget 1120 in both the thickness as well as the diameter directions. The role of the ring 1142 is limited, however, since if its thickness is too large, the current will be restricted or sufficiently blocked to interfere with the formation of a satisfactory nugget 1120.

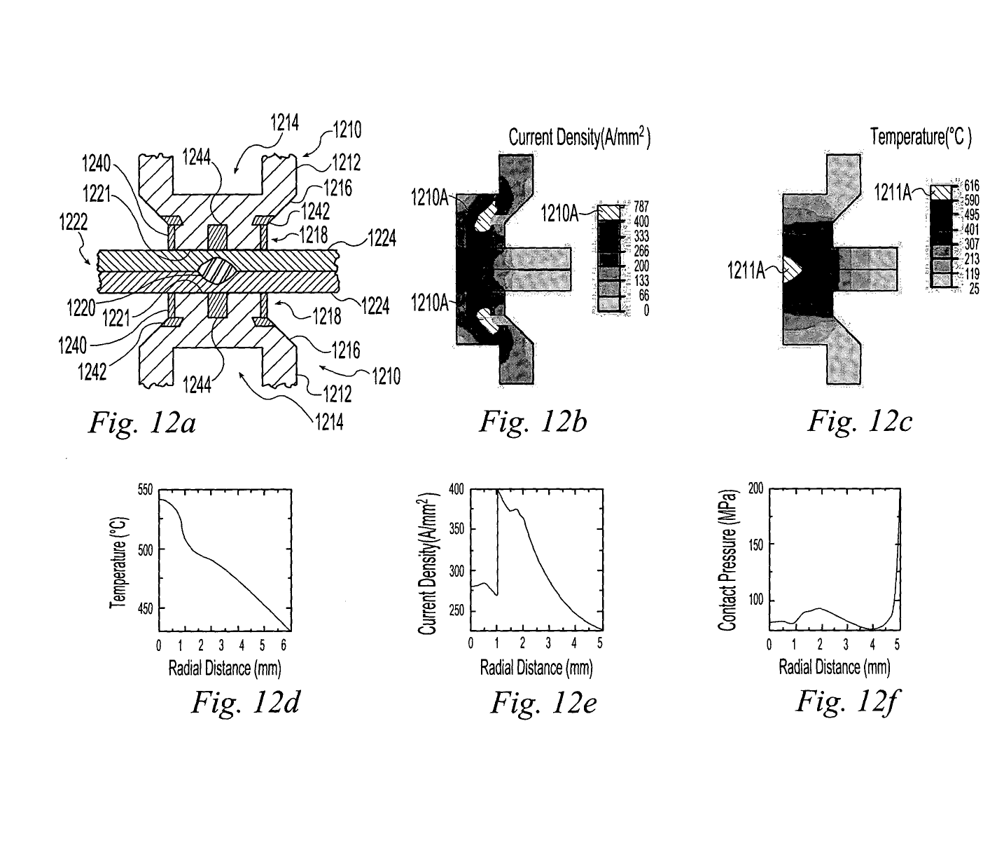

Another modification of the embodiment shown in FIGS. 4a-4f is shown in FIG. 12a-12f. Reference numerals are analogous to those used in FIGS. 4a-4c. Dimensions of analogous structures of the electrodes 1210 are the same. The insert 1244 shown in FIG. 12a, however, is tungsten instead of SS. The nugget 1220 (shown in FIG. 12c as temperature zone 1211A) is 2.7 mm thick, or 68 percent of the total 4 mm thickness of workpiece 1222. The diameter of the nugget 1220 is 4 mm. Compared with FIG. 6c (sleeve 640 alone), 8c (insert 844 alone), and 10c (ring 1042 alone), the size of the nugget 1220 (temperature zone 1211A in FIG. 12c) is increased primarily in the thickness direction when the three elements are incorporated into the same electrode.

FIG. 12d shows the insert 1244 experiencing the highest temperature while the sleeve 1240 takes the high pressure at the periphery of the electrode 1210.

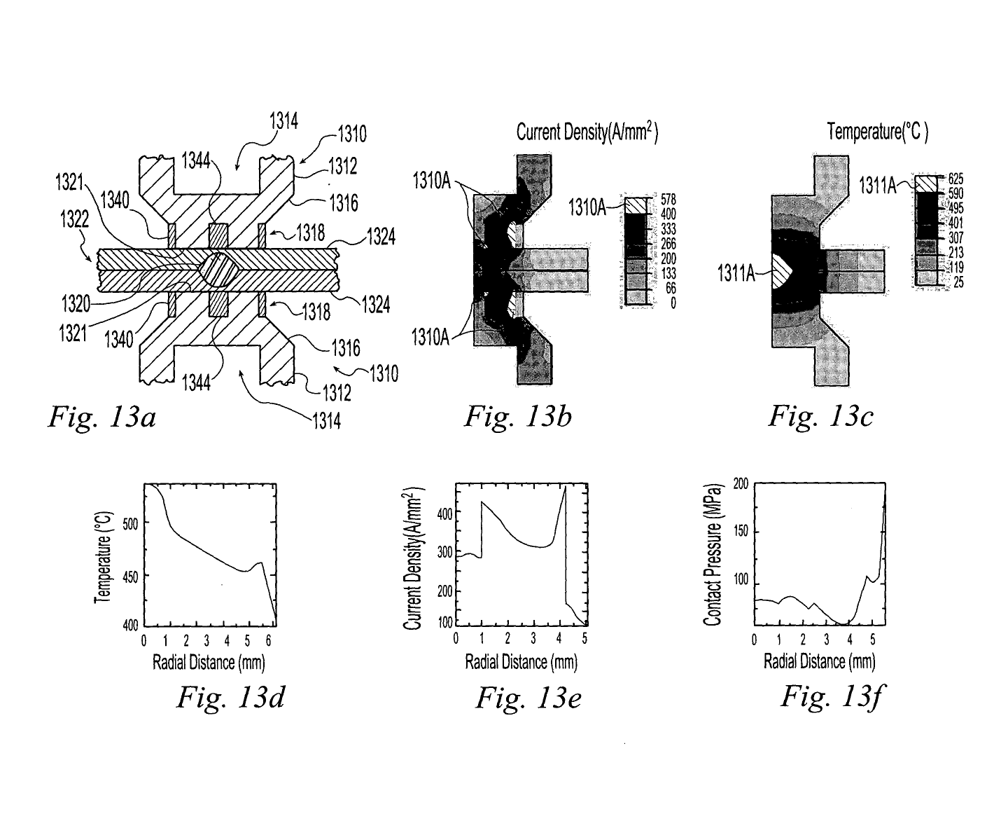

Another embodiment of the present invention is shown in FIG. 13a. Reference numerals are analogous to those used in FIGS. 4a-4c. Dimensions of analogous structures of the electrodes 1310 are the same as those in the electrodes 410 shown in FIG. 4a. The electrode 1310 shown in FIG. 13a, however, comprises only an added tungsten insert 1344 and an added SS sleeve 1340.

In the example shown in FIGS. 13b-13f, the insert 1344 has a diameter of 2 mm and a height in the axial direction of 2.4 mm. The sleeve 1340 has a thickness in the radial direction of 0.75 mm and a height in the axial direction of 2.4 mm. In this example, the insert 1344 is tungsten and the sleeve 1342 is SS. The nugget 1320 (shown in FIG. 13c as temperature zone 1311A) is 3.3 mm thick, or 82 percent of the total 4 mm thickness of the workpiece 1322. The diameter of the nugget 1320 is 4.25 mm.

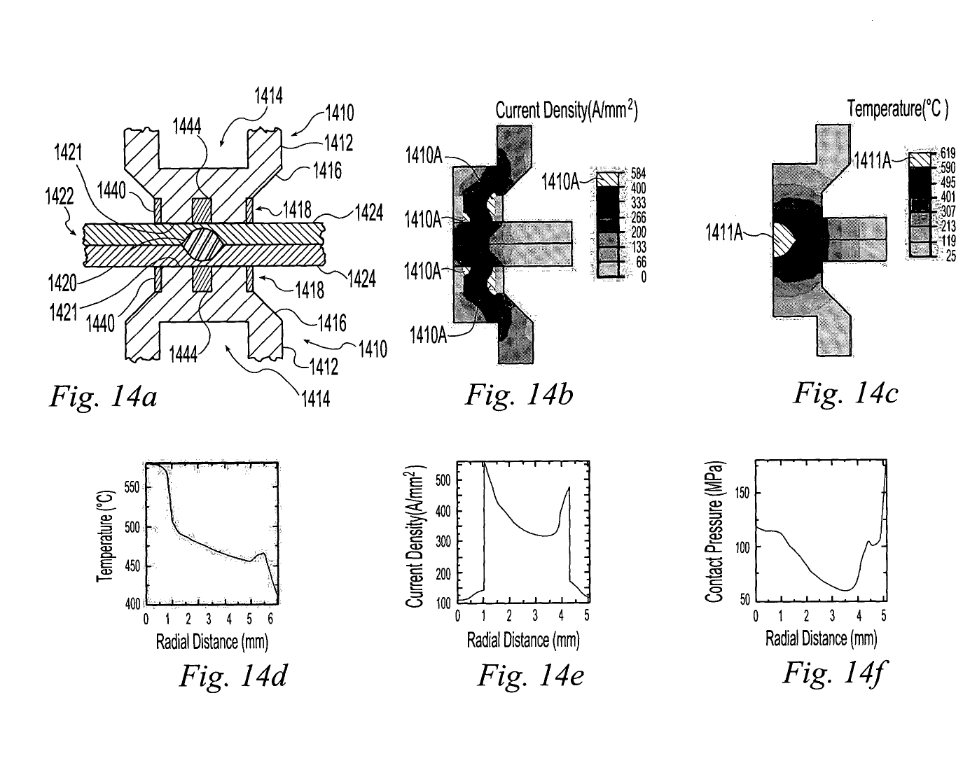

Another embodiment of the instant invention is shown in FIG. 14a. Reference numerals are analogous to those used in FIGS. 4a-4c. Dimensions of analogous structures of the electrodes 1410 are the same as those in the electrodes 410 shown in FIG. 4a. The electrode 1410 shown in FIG. 14a, however, comprises only an added insert 1444 and an added sleeve 1440.

In the example shown in FIGS. 14b-14f, the insert 1444 and the sleeve 1440 are the same dimensions as those in the example shown in FIGS. 13b-13f. In the instant example, however, the insert is 304 SS. The nugget 1420 (shown in FIG. 14c as temperature zone 1411A) is 2.8 mm thick, or 70 percent of the total 4 mm thickness of the workpiece 1422. The diameter of the nugget 1440 is 4.26 mm. The electrode 1410 creates a nugget 1440 of about the same diameter as the nugget 1340 from the electrode 1310 (4.25 mm versus 4.26 mm) but with a more satisfactory thickness (70 percent versus 82 percent) due, at least in part, to the lower thermal and electrical conductivities of SS versus tungsten.

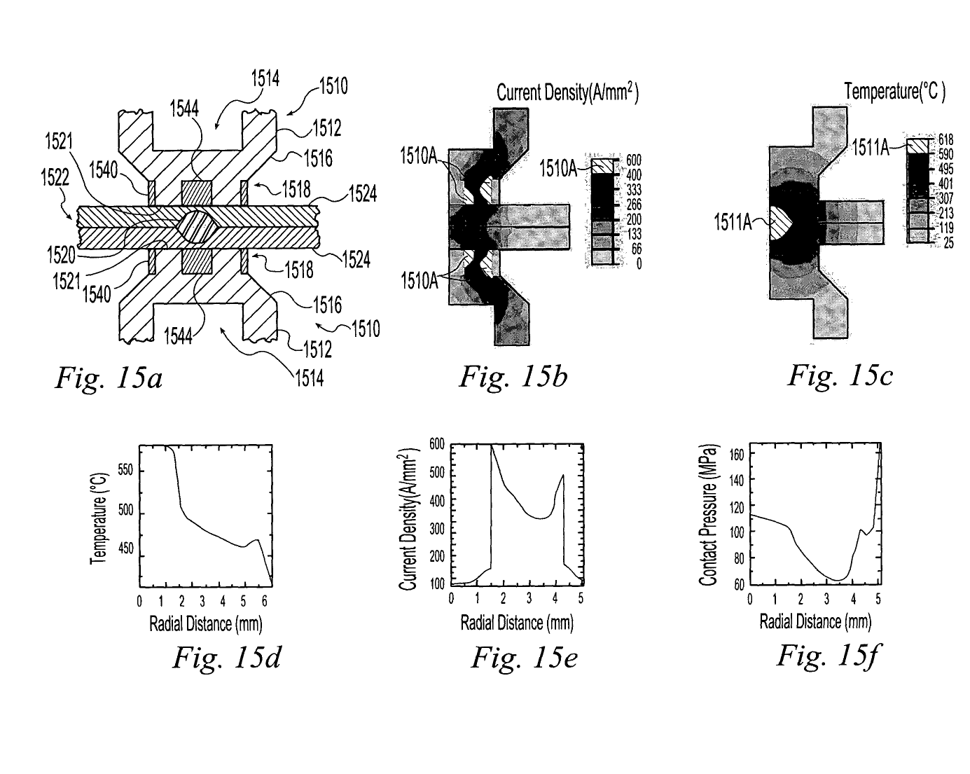

A modification of the embodiment shown in FIGS. 14a-14f is shown in FIG. 15a. Reference numerals are analogous to those used in FIGS. 14a-14c. Dimensions of analogous structures of the electrodes 1510 are the same as those in the electrodes 1410 shown in FIG. 14a with the exception of the insert 1544. As in FIG. 14a, the electrode 1510 comprises both an added insert 1544 and an added sleeve 1540.

In the example shown in FIGS. 15b-15f, the insert 1544 is SS as it is in the example shown in FIGS. 14b-14f but the diameter is 3 mm (versus 2 mm). The dimensions and composition of the sleeve 1540 are the same as the sleeve 1440 in the example shown in FIGS. 14b-14f. The nugget 1520 (shown in FIG. 15c as temperature zone 1511A) is 3.2 mm thick, or 78 percent of the total 4 mm thickness of the workpiece 1522. The diameter of the nugget is 4.76 mm.

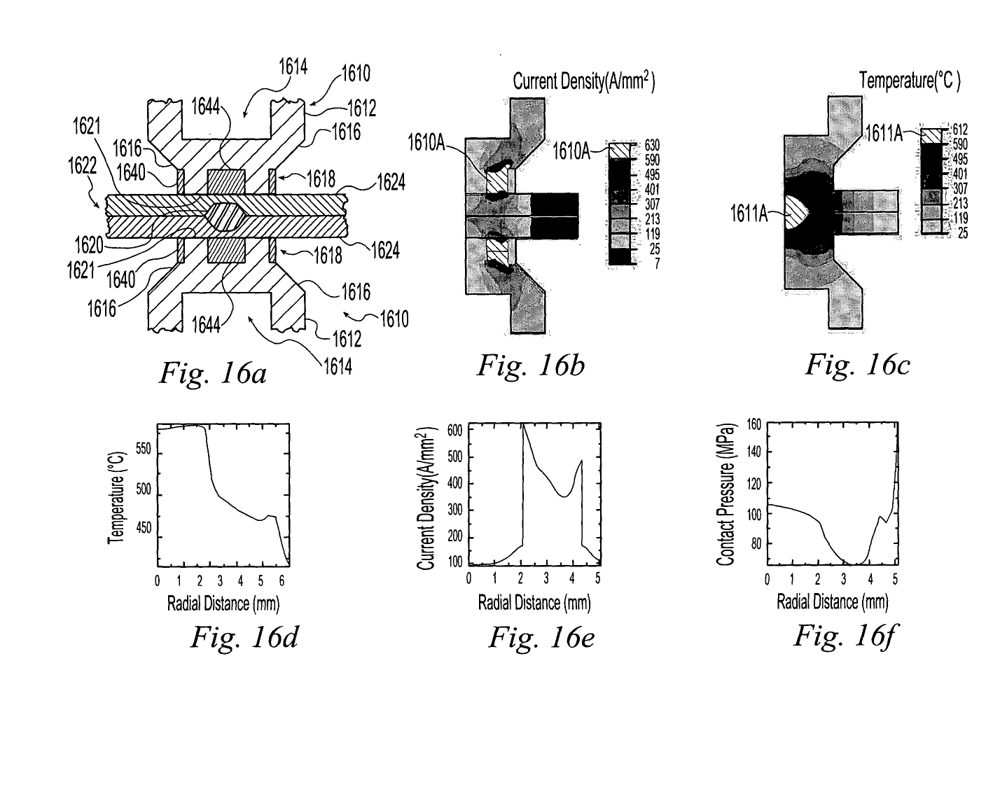

Another modification of the embodiment shown in FIGS. 14a-14f is shown in FIG. 16a. Reference numerals are analogous to those used in FIGS. 14a-14c. Dimensions of analogous structures of the electrodes 1610 are the same as those in the electrodes 1410 shown in FIG. 14a with the exception of the insert 1644. As in FIG. 14a, the electrode 1610 comprises both an added insert 1644 and an added sleeve 1540.

In the example shown in FIGS. 16b-16f, the insert 1644 is SS as it is in the example shown in FIGS. 14b-14f but the diameter is 4 mm. The dimensions and composition of the sleeve 1640 are the same as the sleeve 1440 in the example shown in FIGS. 14b-14f. The nugget 1620 (shown in FIG. 16c as temperature zone 1611A) is 2.66 mm thick, or 67 percent of the total 4 mm thickness of the workpiece 1622. The diameter of the nugget 1620 is 5.1 mm. This electrode 1610 not only produces a nugget 1620 with an improved diameter (5.1 mm versus 4.76 mm), but produces a thickness which is more desirable (67 percent versus 78 percent) which minimizes overheating of the electrode 1610.

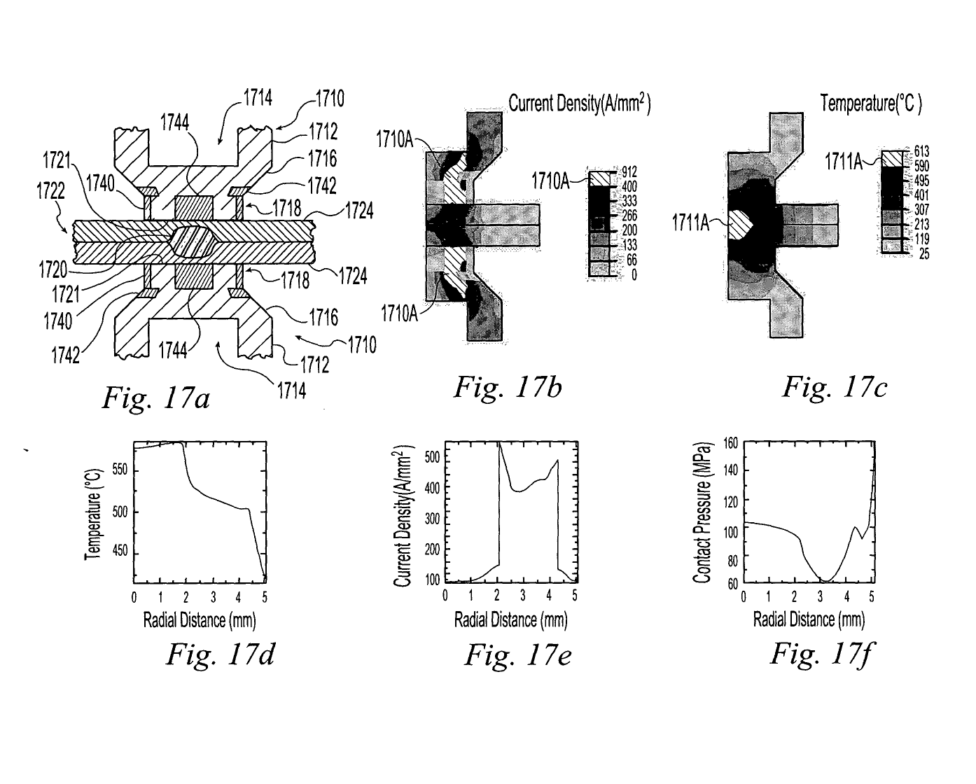

A preferred modification of the embodiment shown in FIGS. 4a-4f is shown in FIG. 17a. Reference numerals are analogous to those used in FIGS. 4a-4c. Dimensions of analogous structures of the electrodes 1710 are the same as those in the electrodes 410 shown in FIG. 4a with the exception of the insert 1744. As in FIG. 4a, the electrode 1710 comprises an added insert 1744, an added sleeve 1740, and an added ring 1742. The insert 1744 in the examples shown in FIGS. 17b-17f is 4 mm in diameter. The nugget 1720 (shown in FIG. 17c as temperature zone 1711A) is 2.86 mm thick, or 72 percent of the total 4 mm thickness of the workpiece 1722. The diameter of the nugget 1720 is 5.5 mm.

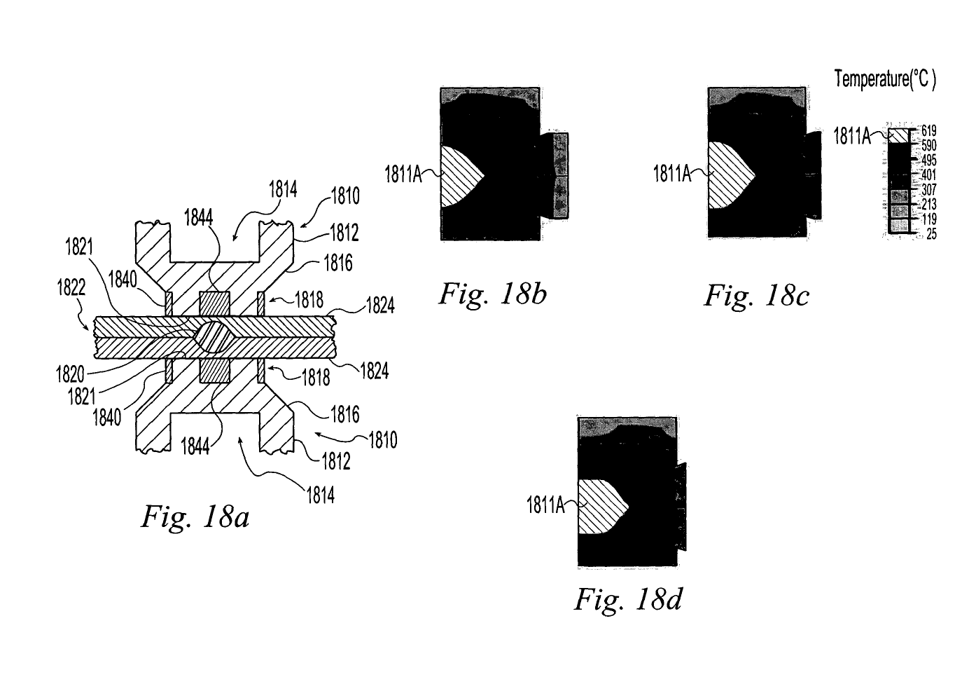

FIGS. 18a-18d (FIG. 18a is referenced as above.) illustrate the affects of changing the diameter of the insert 1828 of SS on the size and proportions of the nugget 1820. The electrode 1810 also includes a sleeve 1840 of 304 SS. All other basic dimensions are the same as earlier versions. Table 7 below compares the proportions of the nugget 1820.

TABLE 7

| | | | | |
|---|---|---|---|---|
| Co-axial Insert Thickness (mm) | 0 | 2 | 3 | 4 |
| Nugget Thickness (mm) | 0.96 | 2.80 | 3.20 | 2.66 |
| Nugget Diameter (mm) | 3.10 | 4.26 | 4.76 | 5.01 |
| Nugget Vertical Coverage (%) | 24 | 70 | 80 | 67 |

Thus, as the diameter of the co-axial insert 1844 increases from 2 mm to 3 mm, the nugget 1820 increases in both thickness and diameter. When the diameter of the co-axial insert 1844 is further increased to 4 mm, however, the diameter of the nugget 1820 increases but the thickness decreases. As shown in Table 8 below, it is known that the electrical and thermal conductivity of the 304 SS, particularly compared with tungsten, is low enough that the larger-diameter SS insert 1844 prevents current from directly flowing beneath the electrode 1810, thus forming a thinner nugget 1820. This phenomenon also causes more current to be shifted radially outward, which produces a larger-diameter nugget 1820.

TABLE 8

| | | |
|---|---|---|
| Property/Material | 304 SS | Tungsten |
| Thermal Conductivity (J/s-mm-° C.) | 0.014 | 0.13 |
| Electrical Conductivity (Ω⁻¹mm⁻¹) | 0.138E+4 | 1.81E+4 |

### SOURCE

Marks' Standard Handbook for Mechanical Engineering 14 Eugene A. Avallone and Theodore Baumeister III eds., 9th ed. (1987).

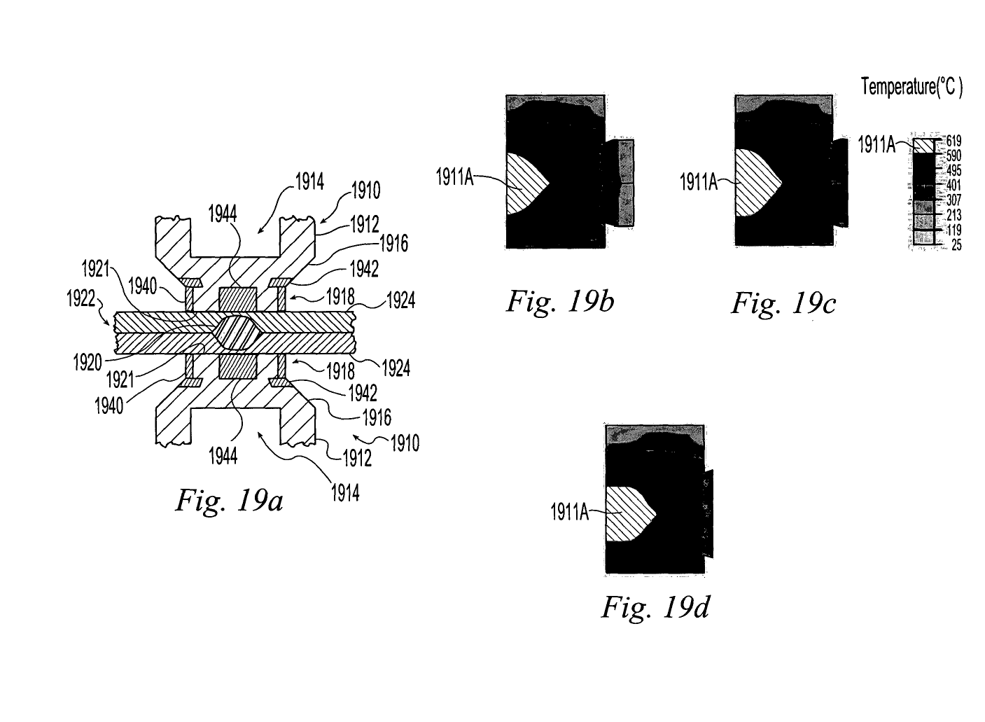

FIGS. 19a-19d (FIG. 19a is as referenced above.) illustrate the affects of changing the diameter of a SS insert 1928 on the size and proportions of the nugget 1920. The electrode 1910 also comprises a SS sleeve 1940 having a thickness in the radial direction of 0.75 mm and a SS ring 1942 having a thickness in the radial direction of 1.5 mm. All other basic dimensions are the same as earlier versions. Table 9 below compares the proportions of the nugget 1920.

TABLE 9

| | | | | |
|---|---|---|---|---|
| Co-axial Insert Thickness (mm) | 0 | 2 | 3 | 4 |
| Nugget Thickness (mm) | 0.96 | 3.34 | 3.34 | 2.86 |
| Nugget Diameter (mm) | 3.1 | 4.5 | 5.0 | 5.5 |
| Nugget Vertical Coverage (%) | 24 | 84 | 84 | 72 |

Thus, adding the ring 1942, in addition to the insert 1944 and the sleeve 1940, effects a significant increase in the diameter of the nugget 1920 and only a slight increase in the thickness of the nugget 1920. The ring 1942 effects a redistribution of the current flow in an outward radial direction, which increases the diameter of the nugget 1920.

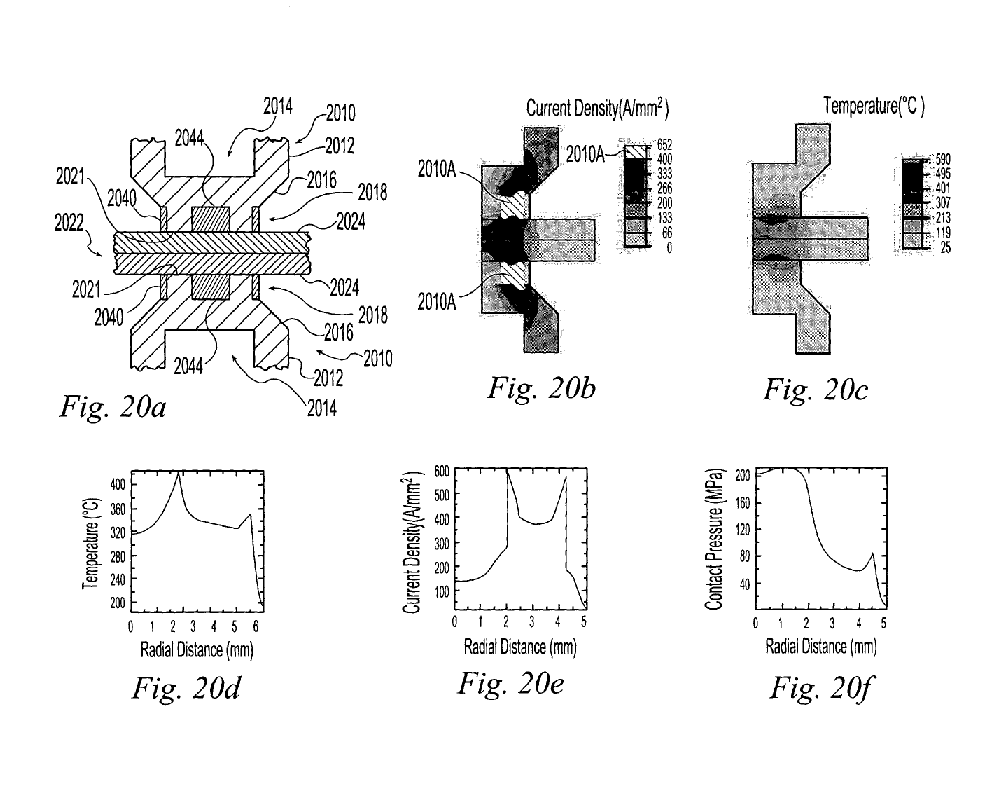

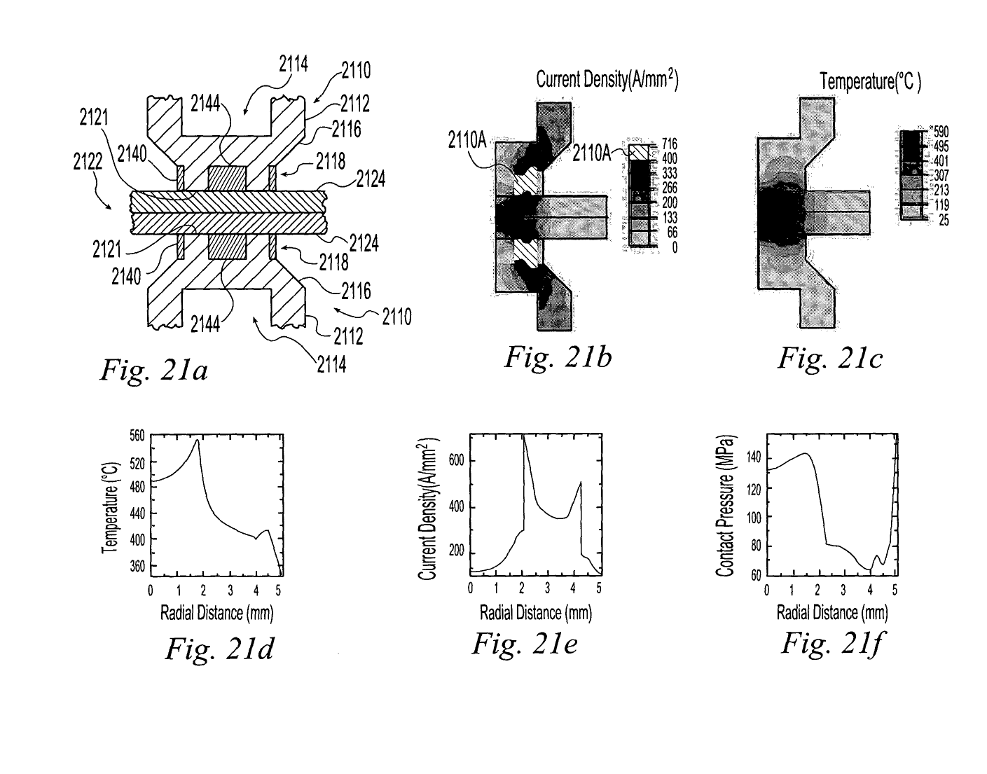

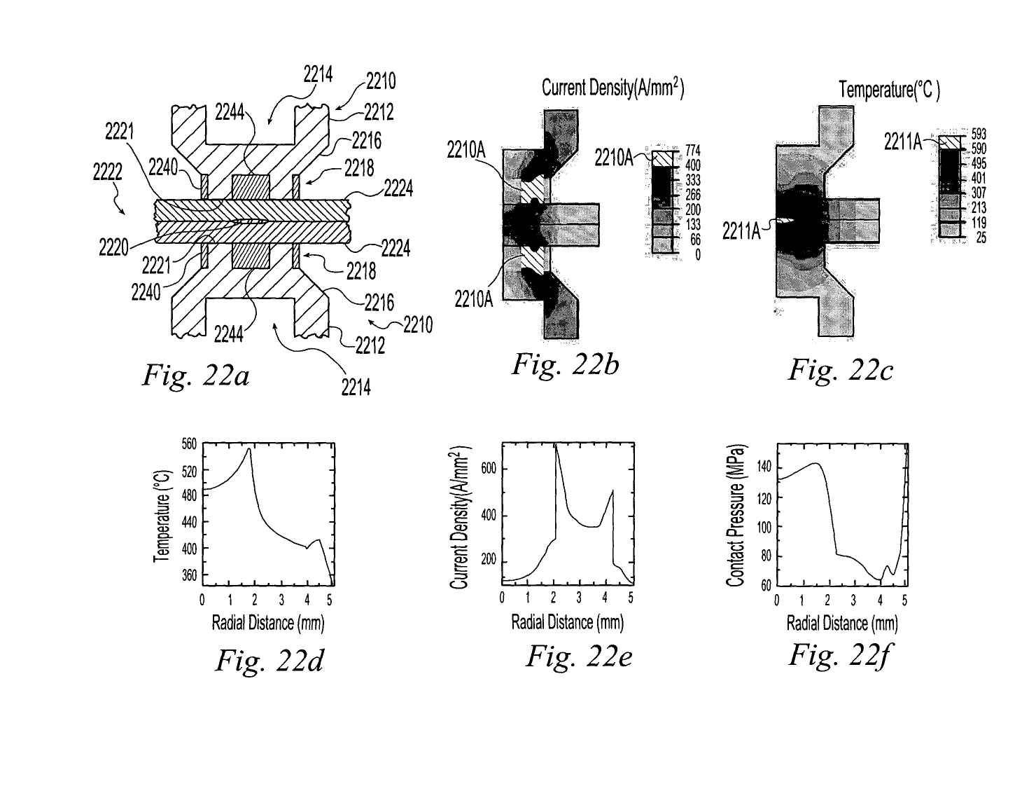

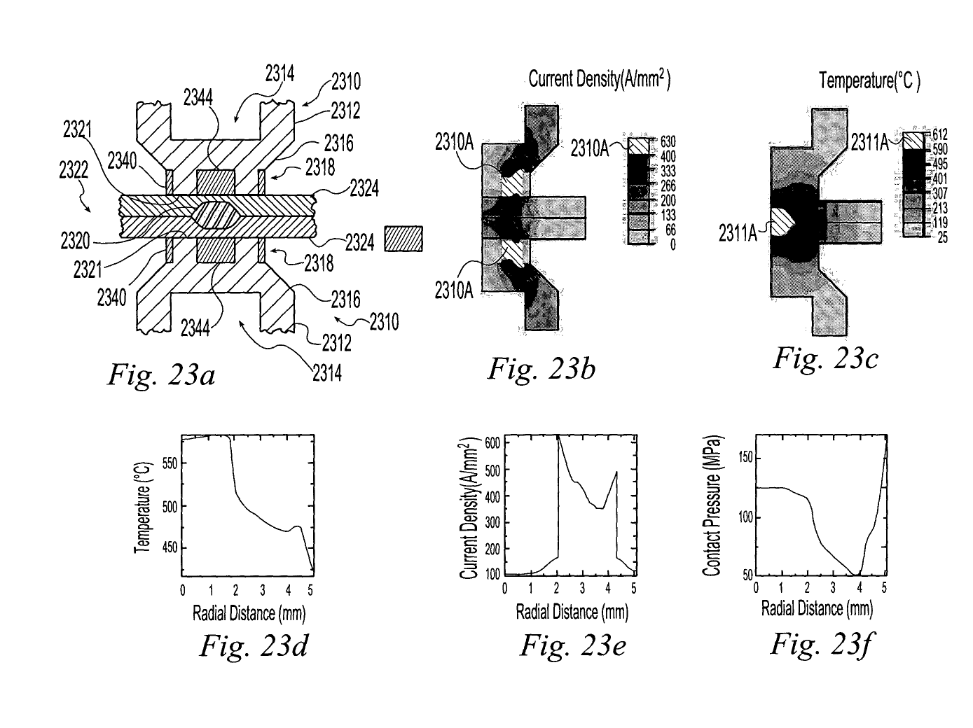

FIGS. 20a-23e illustrate the dynamic process of the development of a weld nugget by examining temperature, current flow, and contact pressure at the interface between the electrode tip and the workpiece. The embodiment used comprised a 4 mm diameter SS insert (e.g., 2044) and a SS sleeve (e.g., 2040) having a dimension in the radial direction of 0.75 mm. FIGS. 20b-20f show the results with two and one-half current cycles. As shown in FIGS. 20b and 20c, although there is good current density, the workpiece 2022 does not reach the temperature necessary to form a nugget. FIGS. 21b-21f show the results with five current cycles. As with the previous version, no nugget is formed (FIGS. 21b and 21c). FIGS. 22a-22f show the results with seven and one-half current cycles. A small, but insufficient, nugget 2220 is formed. The nugget 2220 has a thickness of 0.67 mm and a diameter of 3.5 mm. Finally, FIGS. 23a-23f show the results with ten current cycles. A satisfactory nugget 2320 is formed with a thickness of 2.66 mm and a diameter of 5.1 mm.

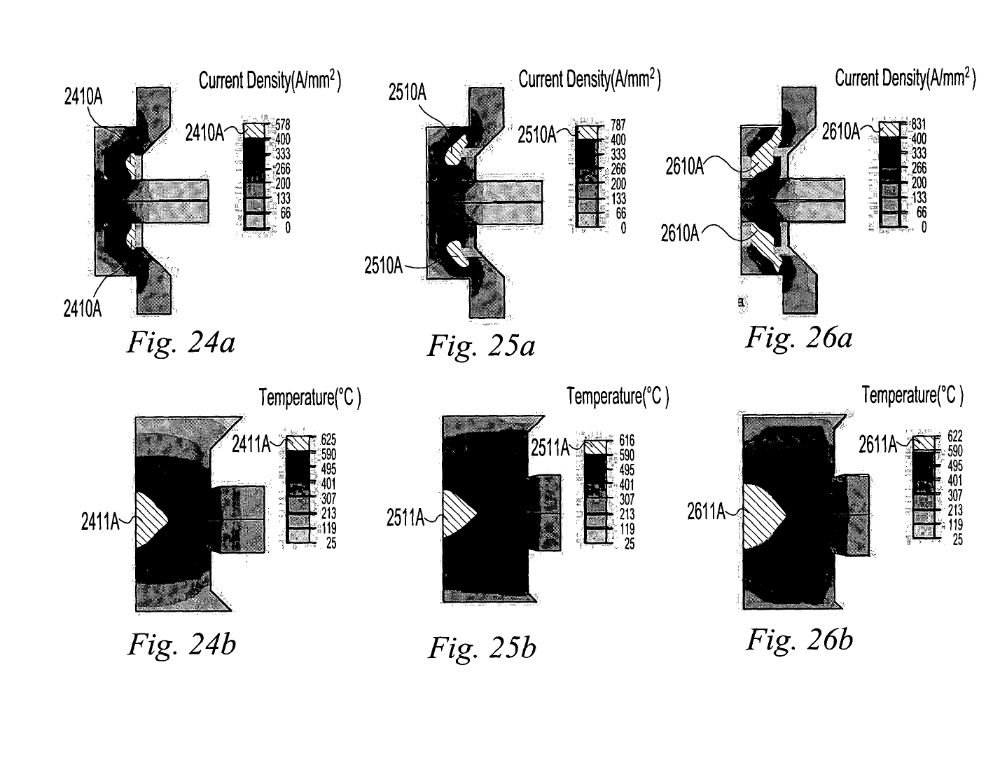

FIGS. 24a and 24b show the results of an FEA for an electrode of the present invention. The electrode has a tungsten insert with a diameter of 2 mm and a SS sleeve with a thickness in the radial direction of 0.75 mm. As shown by the temperature zone 2411A in FIG. 24b, a nugget is formed with a thickness of 3.34 mm (vertical coverage of 84 percent) and a diameter of 4.26 mm.

FIGS. 25a and 25b show the results of an FEA for another electrode of the present invention. The electrode has tungsten insert with a diameter of 2 mm and a SS ring with a thickness in the radial direction of 1.5 mm. As shown by the temperature zone 2511A in FIG. 25b, a nugget is formed with a thickness of 2.54 mm (vertical coverage of 64 percent) and a diameter of 4.06 mm.

FIGS. 26a and 26b show the results of an FEA for another electrode of the present invention. The electrode has a tungsten insert with a diameter of 2 mm, a SS ring with a thickness in the radial direction of 1.5 mm, and a SS sleeve with a thickness in the radial direction of 0.75.

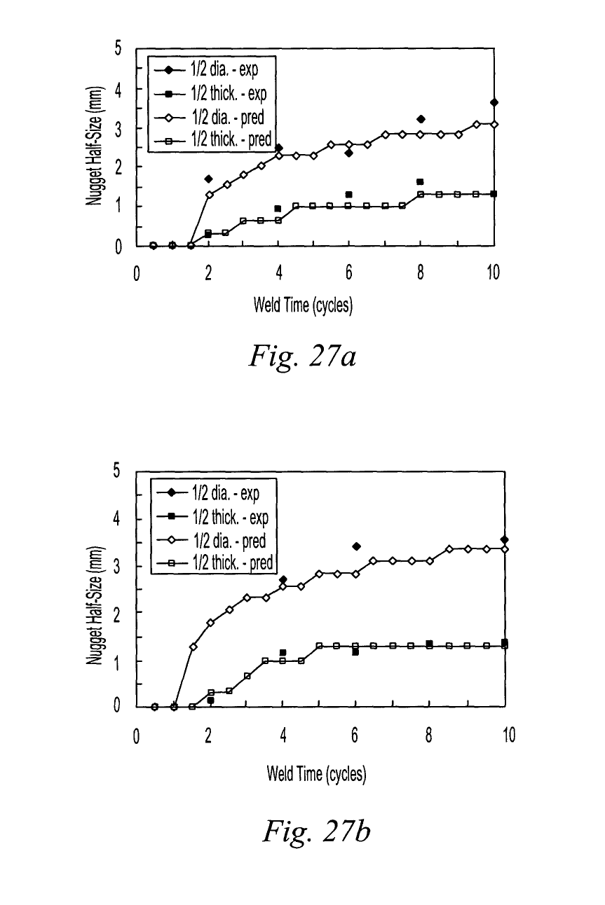

FIGS. 27a and 27b show the results of evaluations of the accuracy of FEA for use in predicting nugget formation. The basis for both FIGS. 27a and 27b is two sheets of 2.0 mm galvanized steel as the workpiece and a pair of dome-shaped electrodes. To conform to the FEA analyses, the results as reported herein are for half-dimensions. Actual nugget sizes are double those shown. FIG. 27a shows the results of experimental and predicted nugget size versus weld cycles at 26 KA and a weld force of 800 pounds-force. FIG. 27b shows results at 29.5 KA and 1100 pounds-force. As FIGS. 27a and 27b show, there is good agreement.

Although the invention has been described in detail with reference to certain preferred embodiments, variations and modifications exist within the scope and spirit of the invention as described and defined in the following claims.

1. A composite resistance spot welding electrode comprising:
(a) a shank portion;
(b) a transition portion integral with the shank portion, the transition portion comprising:
(i) an annular groove co-axial with the transition portion; and
(ii) a co-axial neck ring contained within the annular groove; and
(c) a tip portion integral with the transition portion, the tip portion comprising:
(i) a co-axial cavity having an opening to a tip portion end distal to the transition portion;
(ii) an insert contained within the cavity, the insert having an end co-terminus with the distal tip portion end; and
(iii) a co-axial annular outer sleeve, the sleeve having an end co-terminus with the distal tip portion end, the tip portion end, the insert, and the sleeve end cooperating to form a flat face; wherein
(d) the insert comprises no more than about 40 percent of the area of the face; and
(e) the sleeve has a thickness in the radial direction of about 10-20 percent of the radius of the face.

2. The electrode of claim 1, wherein the ring, the insert, and the sleeve are formed from stainless steel.

3. The electrode of claim 2, wherein the stainless steel is 304 stainless steel.

4. The electrode of claim 3, wherein the insert comprises about 16 percent of the area of the face.

5. The electrode of claim 3, wherein the sleeve has a thickness in the radial direction of about 15 percent of the radius of the face.

6. A first and a second electrode, each electrode according to claim 1, wherein when:
(a) the first and second electrodes are placed in a facing, spaced-apart relationship;
(b) a workpiece comprising two sheets of 2 mm-thick 5XXX aluminum are placed therebetween;
(c) the first and second electrodes compress the workpiece with a force of about 700-2000 pounds-force; and
(d) a 60-Hz current of about 20-30 KA is passed through the workpiece for 8-12 cycles;
(e) a nugget is formed with a thickness of between 0.8-3.4 mm and a diameter of between 2-6 mm.

7. The electrodes of claim 6, wherein:
(a) the compressive force is about 1550 pounds-force;
(b) the current is about 22 KA; and
(c) the nugget thickness is about 2.7-3.4 mm.

8. A composite resistance spot welding electrode comprising:
(a) a shank portion;
(b) a tip portion integral with the shank portion, the tip portion comprising a co-axial annular outer sleeve, the sleeve having an end co-terminus with a tip portion end distal to the shank portion, the tip portion end and the sleeve end cooperating to form a smooth, continuous tip face; wherein
(c) the sleeve has a thickness in the radial direction of about 10-30 percent of the outside radius of the sleeve.

9. The electrode of claim 8, wherein the sleeve is formed from a material selected from the group consisting of steel and tungsten.

10. The electrode of claim 9, wherein the steel is stainless steel.

11. The electrode of claim 10, wherein the sleeve has a thickness in the radial direction of about 15 percent of the outside radius of the face.

12. A first and a second electrode, each electrode according to claim 8, wherein when:
(a) the first and second electrodes are placed in a facing, spaced-apart relationship;
(b) a workpiece comprising two sheets of 2 mm-thick 5XXX aluminum are placed therebetween;
(c) the first and second electrodes compress the workpiece with a force of about 700-2000 pounds-force; and
(d) a 60-Hz current of about 20-30 KA is passed through the workpiece for 10 cycles;
(e) a nugget is formed with a thickness of between 0.8-3.4 mm and a diameter of between 2-6 mm.

13. The electrodes of claim 12, wherein:
(a) the compressive force is about 1550 pounds-force;
(b) the current is about 22 KA; and
(c) the nugget thickness is about 2.7-3.4 mm.

14. A composite resistance spot welding electrode comprising:
(a) a shank portion
(b) a tip portion integral with the shank portion, the tip portion comprising:
(i) a co-axial cavity having an opening to a tip portion end distal to the shank portion; and
(ii) an insert contained within the cavity, the insert having an end co-terminus with the distal tip portion end, the tip portion end and the insert cooperating to form a smooth, continuous tip face; wherein
(c) the diameter of the insert is no more than about 50 percent of the diameter of the tip.

15. The electrode of claim 14, wherein the insert is formed from a material selected from the group consisting of steel and tungsten.

16. The electrode of claim 15, wherein the steel is stainless steel.

17. A first and a second electrode, each electrode according to claim 14, wherein when:
(a) the first and second electrodes are placed in a facing, spaced-apart relationship;
(b) a workpiece comprising two sheets of 2 mm-thick 5XXX aluminum are placed therebetween;
(c) the first and second electrodes compress the workpiece with a force of about 700-2000 pounds-force; and
(d) a 60-Hz current of about 20-30 KA is passed through the workpiece for 10 cycles;
(e) a nugget is formed with a thickness of between 0.8-3.4 mm and a diameter of between 2-6 mm.

18. The electrodes of claim 17, wherein:
(a) the compressive force is about 1550 pounds-force;
(b) the current is about 22 KA; and
(c) the nugget thickness is about 2.7-3.4 mm.

19. The electrode of claim 14, the tip portion further comprising:
(a) a co-axial annular outer sleeve, the sleeve having an end co-terminus with the distal tip portion end, the tip portion, the insert, and the sleeve end cooperating to form a smooth, continuous tip face; wherein
(b) the annular sleeve has a thickness in the radial direction of about 5-15 percent of the outside diameter of the sleeve.

20. The electrode of claim 19, wherein the insert and the sleeve are formed from a material selected from the group consisting of steel and tungsten.

21. The electrode of claim 20, wherein the steel is stainless steel.

22. A first and a second electrode, each electrode according to claim 19, wherein when:
(a) the first and second electrodes are placed in a facing, spaced-apart relationship;
(b) a workpiece comprising two sheets of 2 mm-thick 5XXX aluminum are placed therebetween;
(c) the first and second electrodes compress the workpiece with a force of about 700-2000 pounds-force; and
(d) a 60-Hz current of about 20-30 KA is passed through the workpiece for 10 cycles;
(e) a nugget is formed with a thickness of between 0.8-3.4 mm and a diameter of between 2-6 mm.

23. The electrodes of claim 22, wherein:
(a) the compressive force is about 1550 pounds-force;
(b) the current is about 22 KA; and
(c) the nugget thickness is about 2.7-3.4 mm.

24. A method of resistance spot welding comprising:
(a) providing a first and a second electrode, each electrode according to claim 1;
(b) placing the first and second electrodes in a facing, spaced-apart relationship;
(c) placing a workpiece comprising two sheets of metal therebetween; and
(d) urging the first and second electrodes together to compress the workpiece; and
whereby:
(i) a nugget is formed.

25. A composite resistance spot welding electrode comprising:
(a) a shank portion;
(b) a transition portion integral with the shank portion, the transition portion comprising:
(i) an annular groove co-axial with the transition portion; and
(ii) a co-axial neck ring contained within the annular groove;
(c) a tip portion integral with the transition portion, the tip portion having a tip face distal to the transition portion; and
(d) a coolant channel, the coolant channel having a closed end proximate to the tip face; wherein
(e) the neck ring has a thickness in the axial direction of between 10-40 percent of the distance from the tip face to the bottom of the coolant channel.

26. A composite resistance spot welding electrode comprising:
(a) a shank portion;
(b) a transition portion integral with the shank portion, the transition portion comprising:
(i) an annular groove co-axial with the transition portion; and
(ii) a co-axial neck ring contained within the annular groove; and
(c) a tip portion integral with the transition portion, the tip portion comprising:
(i) a co-axial cavity having an opening to a tip portion end distal to the transition portion;
(ii) an insert contained within the cavity, the insert having an end co-terminus with the distal tip portion end; wherein
(d) the diameter of the insert is no more than about 50 percent of the diameter of the tip.

27. A composite resistance spot welding electrode comprising:
(a) a shank portion;
(b) a transition portion integral with the shank portion, the transition portion comprising:
(i) an annular groove co-axial with the transition portion; and
(ii) a co-axial neck ring contained within the annular groove; and
(c) a tip portion integral with the transition portion, the tip portion comprising:
(i) a co-axial annular sleeve, the sleeve having an end co-terminus with the distal tip portion end; wherein
(d) the annular sleeve has a thickness in the radial direction of about 5-15 percent of the outside diameter of the sleeve.

28. In a composite resistance spot welding electrode for welding a workpiece, a weld tip for applying pressure to a workpiece to be welded, the weld tip comprising:
(a) a conductive inner portion having an end surface for contacting the workpiece; and
(b) a high-strength, low-conductivity outer sleeve, the sleeve having an end surface which cooperates with the inner portion end surface to form a continuous face therewith.

29. The weld tip of claim 28, wherein the sleeve is formed from a material selected from the group consisting of steel and tungsten.

30. A method of resistance spot welding comprising:
(a) providing a first and second electrode, each electrode comprising a tip according to claim 28;
(b) placing the first and second electrodes in a facing, spaced-apart relationship;
(c) placing a workpiece comprising two sheets of metal therebetween;
(d) urging the first and second electrodes together to compress the workpiece; and
(e) passing an electric current through the workpiece; whereby
(f) a nugget is formed.

31. The weld tip of claim 28, wherein during a weld operation on the workpiece:
(a) a contact pressure maximum occurs at an interface between the workpiece and the sleeve end surface.

32. A method of resistance spot welding a workpiece comprising the steps of:
(a) applying pressure against the workpiece with a first and a second electrode in a facing, spaced-apart relationship, each electrode comprising a tip according to claim 28; and
(b) passing an electric current through the workpiece; whereby:
(i) a contact pressure maximum occurs between the workpiece and each electrode face at the sleeve end surface.

33. The weld tip of claim 28, wherein:
(a) an electric current flowing through the weld tip is directed toward the center of the planar face.

34. A method of resistance spot welding a workpiece comprising the steps of:
(a) providing a first and second electrode, each electrode comprising a tip according to claim 33;
(b) placing the workpiece comprising two sheets of metal therebetween;
(c) urging the first and second electrodes together to compress the workpiece; and
(d) passing an electric current through the first and second electrodes; whereby
(i) the electric current flowing through the first and second electrodes is directed toward the center of the first and second planar face, respectively.
